(19) United States
(12) Patent Application Publication
(10) Pub. No.: US 2022/0156554 A1
(43) Pub. Date: May 19, 2022

(54) Lightweight Decompositional Convolution Neural Network

(71) Applicant: Northeastern University, Boston, MA (US)

(72) Inventors: Yun Fu, Brookline, MA (US); Bin Sun, Boston, MA (US)

(21) Appl. No.: 17/594,061

(22) PCT Filed: Jun. 3, 2020
(86) PCT No.: PCT/US20/35993

§ 371 Date: Sep. 30, 2021

Related U.S. Application Data
(60) Provisional application No. 62/857,248, filed on Jun. 4, 2019.
(60) Provisional application No. 62/935,724, filed on Nov. 15, 2019.

(51) Int. Cl. G06N 3/04; G06N 3/08

(52) U.S. Cl. CPC G06N 3/04; G06N 3/08

(57) ABSTRACT

A neural network (NN) and corresponding method employ an NN element (NNE) that includes a depthwise convolutional layer (DCL). The DCL outputs respective features by performing spatial convolution of respective input features having an original number of dimensions. The NNE includes a compression-expansion (CE) module that includes a first convolutional layer (CL) and second CL. The first CL outputs respective features as a function of respective input features. The respective features output from the first CL have a reduced number of dimensions relative to the original number of dimensions. The second CL outputs respective features, having the original number of dimensions, as a function of the respective features output from the first CL. The NNE further includes an add operator that outputs respective features as a function of the respective features output from the second CL and DCL. The NNE enables the NN to have a reduced size and to process data with competitive performance relative to conventional lightweight deep neural networks.

### RELATED APPLICATIONS

This application claims the benefit of U.S. Provisional Application No. 62/935,724, filed on Nov. 15, 2019 and U.S. Provisional Application No. 62/857,248, filed on Jun. 4, 2019. The entire teachings of the above applications are incorporated herein by reference.

### BACKGROUND

Deep learning is one of the foundations of artificial intelligence (AI). Deep learning methods have improved the ability of machines to classify, recognize, detect, and describe. For example, deep learning is used to classify images, recognize speech, detect objects, and describe content. In deep learning, a convolutional neural network (CNN) is a class of deep neural networks.

Convolutional neural networks (CNNs) are neural networks and are often used to classify images, cluster images by similarity, and perform object recognition within scenes. For example, CNNs are used to identify faces, street signs, tumors, and many other aspects of visual data. CNNs are powering major advances in computer vision (CV), which has applications for self-driving cars, robotics, drones, security, medical diagnoses, etc.

### SUMMARY

According to an example embodiment, a neural network comprises a neural network element. The neural network element includes a depthwise convolutional layer configured to output respective features by performing spatial convolution of respective input features having an original number of dimensions. The neural network element further includes a first convolutional layer configured to output respective features as a function of respective input features. The respective features output from the first convolutional layer have a reduced number of dimensions relative to the original number of dimensions. The neural network element further includes a second convolutional layer configured to output respective features as a function of the respective features output from the first convolutional layer. The respective features output from the second convolutional layer have the original number of dimensions. The neural network element further includes an add operator configured to output respective features as a function of the respective features output from the second convolutional layer and the respective features output from the depthwise convolutional layer.

The respective input features to the first convolutional layer may be the respective input features to the depthwise convolutional layer.

The first convolutional layer, second convolutional layer, and depthwise convolutional layer may be further configured to normalize, via batch normalization, the respective features output therefrom. The first convolutional layer and depthwise convolutional layer may be further configured to apply an activation function to the respective features normalized.

The activation function may be a rectified linear unit (ReLU) activation function configured to (i) output a given input feature, directly, in an event the given input feature has a positive value and (ii) output zero for the given input feature, otherwise.

It should be understood, however, that the activation function is not limited to a ReLU activation function. For example, the activation function may be a ReLU6 activation function, Swish activation function, or another non-linear activation function.

The neural network element may further comprise an output processing layer configured to output respective features by normalizing, via batch normalization, the respective features output from the add operator and to apply an activation function to the respective features normalized. The activation function may be a non-linear activation function.

The neural network element may be a depthwise module. The neural network may further comprise a pointwise module. The pointwise module may include a first pointwise convolutional layer configured to output respective features as a function of respective input features, a second pointwise convolutional layer configured to output respective features as a function of respective features output from the first pointwise convolutional layer, and a concatenator configured to output respective features by concatenating the respective features output from the first pointwise convolutional layer with the respective features output from the second pointwise convolutional layer.

The first and second pointwise convolutional layers may be further configured to normalize, via batch normalization, the respective features output therefrom and to apply an activation function to the respective features normalized.

The depthwise convolutional layer may be a first depthwise convolutional layer. The depthwise module may be a first depthwise module, the pointwise module may be a first pointwise module, and the neural network may further comprise a compression module. The compression module may be configured to output respective features as a function of respective input features having the original number of dimensions. The compression module may include a second depthwise convolutional layer, the first pointwise module, and the first depthwise module. The respective features output from the compression module have the reduced number of dimensions. The neural network may further comprise a processing module configured to output respective features as a function of the respective features output from the compression module. The processing module may include a third depthwise convolutional layer and a first concatenator. The neural network may further comprise a recovery module configured to output respective features as a function of the respective features output from the processing module. The recovery module may include a second depthwise module, a second pointwise module, and a second concatenator. The respective features output from the recovery module have the original number of dimensions.

The second depthwise convolutional layer is configured to output respective features by performing spatial convolution of the respective input features to the compression module. The first pointwise module is configured to output respective features as a function of the respective features output from the second depthwise convolutional layer. The first depthwise module is configured to output respective features as a function of the respective features output from the first pointwise module. The third depthwise convolutional layer is configured to output respective features as a function of the respective features output from the first depthwise module. The first concatenator is configured to output respective features by concatenating the respective features output from the first depthwise module with the respective features output from the third depthwise convolutional layer. The second depthwise module is configured to output respective features as a function of the respective features output from the first concatenator. The second pointwise module is configured to output respective features as a function of the respective features output from the second depthwise module. The second concatenator is configured to output respective features from the recovery module by concatenating the respective features output from the second pointwise module with the respective features output from the first depthwise module.

The second and third depthwise convolutional layers may be further configured to normalize, via batch normalization, the respective features output therefrom and to apply an activation function to the respective features normalized.

The respective input features to the first convolutional layer are the respective features output from the depthwise convolutional layer.

The depthwise convolutional layer may be further configured to normalize, via batch normalization, the respective features output therefrom.

The neural network element may further comprise an L2 normalization layer configured to output respective features by applying L2 normalization to the respective features output from the second convolutional layer. The neural network element may be configured to batch normalize the respective features output from the L2 normalization layer.

The add operator may be further configured to output the respective features by adding: the respective feature maps output from the second convolutional layer, normalized by the L2 normalization layer, and batch normalized; and the respective feature maps output from the depthwise convolutional layer.

The neural network element may be further configured to apply an activation function to the respective features output from the add operator. The activation function may be a ReLU activation function. It should be understood, however, that the activation function is not limited to a ReLU activation function. For example, the activation function may be a ReLU6 activation function, Swish activation function, or another non-linear activation function.

The neural network may be a deep convolutional neural network (DCNN). It should be understood, however, that the neural network is not limited to a DCNN and may be another type of neural network.

The neural network may be employed by an application to perform, on a mobile or embedded device, at least one of: face alignment, face synthesis, image classification, or pose estimation. It should be understood, however, that the neural network is not limited to being employed by a mobile or embedded device. Further, the neural network is not limited to being employed by a face alignment, face synthesis, image classification, or pose estimation application and may be employed by another type of application, such as face recognition, etc.

According to another example embodiment, a method of processing data in a neural network may comprise outputting respective features from a depthwise convolutional layer of a network element of the neural network by performing spatial convolution of respective input features having an original number of dimensions. The method may further comprise outputting respective features from a first convolutional layer of the network element as a function of respective input features. The respective features output from the first convolutional layer have a reduced number of dimensions relative to the original number of dimensions. The method may further comprise outputting respective features from a second convolutional layer of the network element as a function of the respective features output from the first convolutional layer. The respective features output from the second convolutional layer have the original number of dimensions. The method may further comprise outputting respective features from an add operator of the network element as a function of the respective features output from the second convolutional layer and the respective features output from the depthwise convolutional layer.

Alternative method embodiments parallel those described above in connection with the example neural network embodiment.

According to another example embodiment, a method for processing data in a neural network may comprise decomposing a larger pointwise convolutional module into two matrices through network learning in the neural network. The larger pointwise convolutional module is larger relative to the two matrices. The method further comprises performing pointwise convolution of input features using the two matrices and compensating for information loss in output features produced via the pointwise convolution performed. The compensating includes applying residual learning to the output features.

It should be understood that example embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a mobile device with an example embodiment of a neural network implemented thereon and a person using the mobile device.

FIG. 1B is a block diagram of an example embodiment of a neural network.

FIG. 1C is a flow diagram of an example embodiment of a method of processing data in a neural network.

FIG. 2A is a block diagram of an example embodiment of a depthwise convolutional module.

FIG. 2B is a block diagram of an example embodiment of a pointwise convolutional module.

FIG. 3A is a block diagram of an example embodiment of a decomposition convolutional module that includes the depthwise convolutional module of FIG. 2A and pointwise convolutional module of FIG. 2B.

FIG. 3B is a table of an example embodiment of comparison results on time and space complexity.

FIG. 4 is a block diagram of a prior art standard convolutional module.

FIG. 5 is a block diagram of a prior art depthwise separable convolutional (DSC) module.

FIG. 6A is a block diagram of an example embodiment of the present invention of a low-rank pointwise residual (LPR) module.

FIG. 6B is a more detailed block diagram of the example embodiment of the LPR module of FIG. 6A.

FIG. 6C is a flow diagram of another example embodiment of the invention in which a method processes data in a neural network.

FIG. 7 is a visualization of an example embodiment of sparse outputs after a pointwise convolutional layer processes an input feature map.

FIG. 8 is a table of example computational costs and parameters for various lightweight modules.

FIG. 9 is a graph of an example embodiment of curves of different rank on a Canadian Institute for Advanced Research (CIFAR)-10 dataset.

FIG. 10 is heatmap visualization of an example embodiment of differences among standard convolution, DSC, and LPR.

FIG. 11 is block diagram of an example embodiment of modules employed in an example embodiment of an implementation of a lightweight deep network by low-rank pointwise residual convolution (LPRNet).

FIGS. 12A-G are graphs of example embodiments of cumulative errors distribution (CED) curves on different test datasets.

FIG. 13 is a visualization of results obtained using different lightweight models.

FIG. 14 is a table of comparisons between example embodiments of LPR methods and state-of-the-art methods on an Annotated Facial Landmarks in the Wild (AFLW) 2000-3D dataset.

FIG. 15 is a block diagram of an example internal structure of a computer optionally within an embodiment disclosed herein.

### DETAILED DESCRIPTION

A description of example embodiments follows.

It should be understood that the term “feature maps” may be referred to interchangeably herein as “features” or “channels.” Such feature maps are convolved features that are generated by convolving image data with a filter (also referred to interchangeably herein as a filter matrix, matrix, or kernel) based on a stride value. The stride value represents a number of pixels by which a given filter slides over an input matrix in a convolution operation. The term “module” may be referred to interchangeably herein as a “neural network element,” “element,” or “structure” and may comprise a single neural network element or multiple neural network elements.

Deep learning has become popular in recent years primarily due to an increase in powerful computing devices becoming available, such as a graphic processing unit (GPU). It is, however, challenging to deploy deep learning models to end-user devices, such as smart phones, or embedded systems with limited resources. Practicability of deploying such deep learning models is restricted by their high time and space complexities. An example embodiment of the present disclosure compresses a deep neural network and increases speed of an underlying model. It is worth noting that the modules and structures disclosed herein can be used on other, more advanced, network architectures than those disclosed herein.

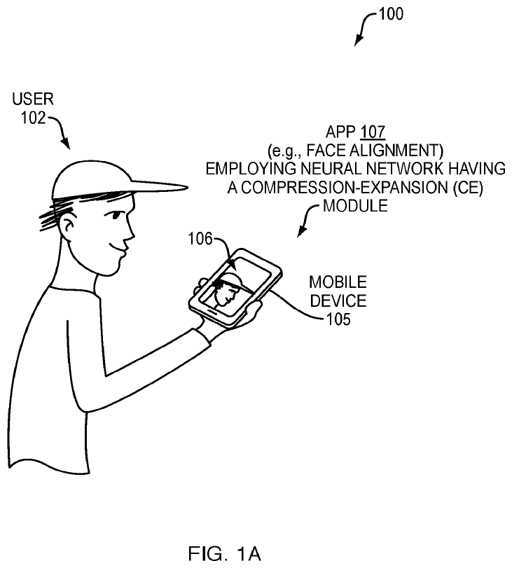

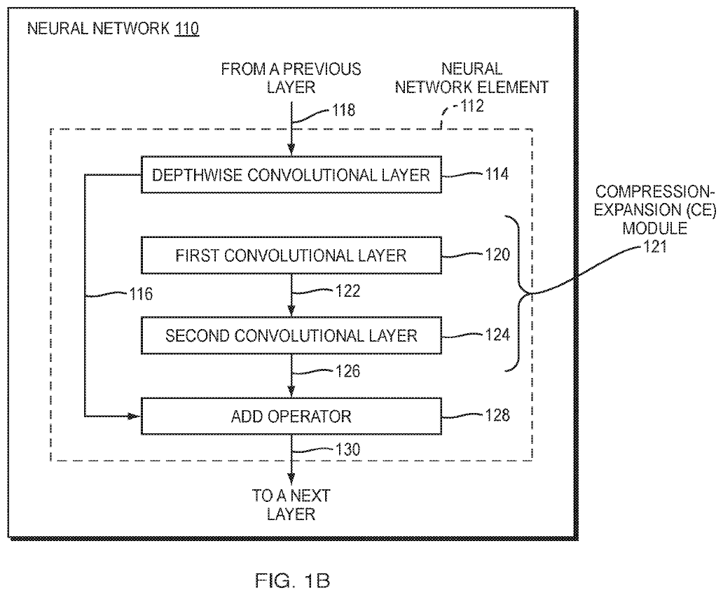

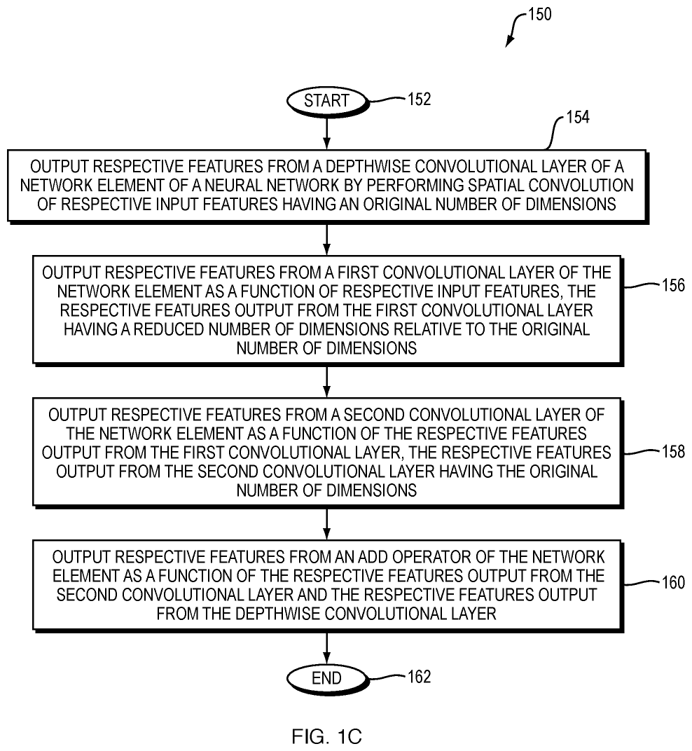

FIG. 1A is a block diagram 100 of an example embodiment of a mobile device 105 that has an example embodiment of a neural network (not shown) implemented thereon. In the block diagram 100, a user 102 is using the mobile device 105. The mobile device 105 is a smartphone with a camera in the example embodiment; however, it should be understood that mobile devices disclosed herein are not limited to smartphones and may be any suitable handheld computer. Also, it should be understood that example embodiments disclosed herein are not limited to mobile or embedded devices. For example, a neural network that includes an example embodiment of a neural network element disclosed herein may be implemented on a mobile or embedded device, remote server, or other computational system.

In the example embodiment of FIG. 1A, the user 102 is using the mobile device 105 to capture a two-dimensional (2D) image 106. The mobile device 105 has an application 107 provided thereon that employs the neural network to process the 2D image 106. For example, the application 107 may employ the neural network to perform face alignment. It should be understood, however, that the application 107 is not limited to employing the neural network to perform face alignment. For example, the application 107 may employ the neural network to perform face synthesis, image classification, pose estimation, or may employ the neural network to perform another task. An example embodiment of the present disclosure can be applied to many exciting human sensing apps, such as virtual face interaction, face recognition, face rendering, body gesture estimation, and other entertainment applications.

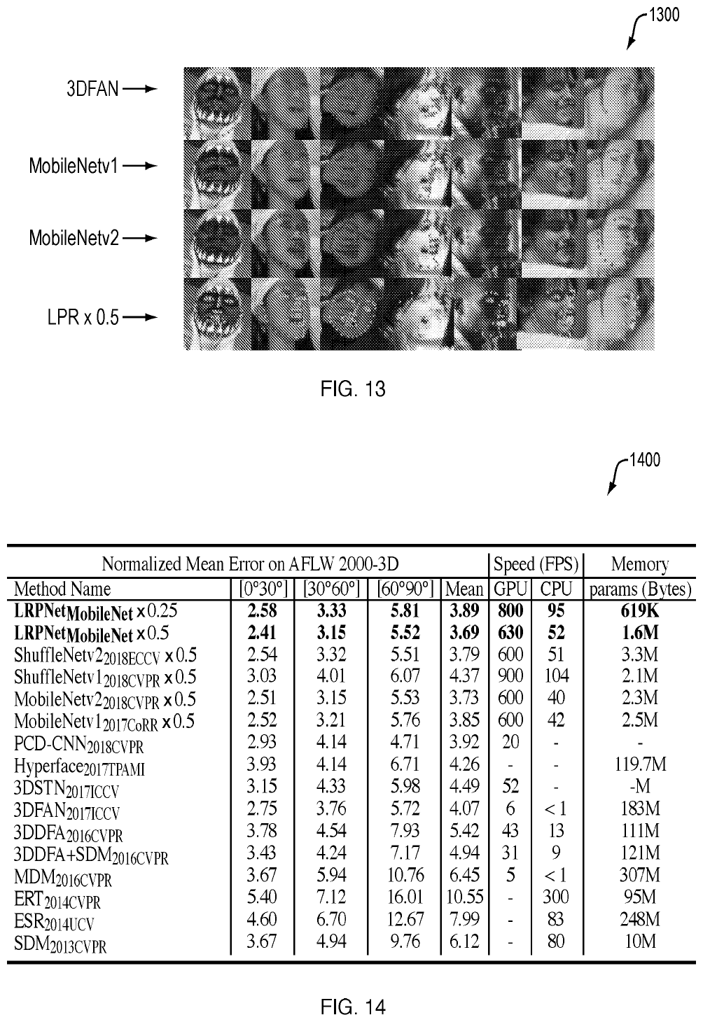

As disclosed above, the application 107 may employ the neural network to perform face alignment. Face alignment is a process of applying a supervised learned model to a digital image of a face and estimating locations of a set of facial landmarks, such as eye corners, mouth corners, etc., of the face, such as the landmarks of the images shown in FIG. 13, disclosed further below. Facial landmarks are certain key points on the face that can be employed for performing a subsequent task focused on the face, such as animation, face recognition, gaze detection, face tracking, expression recognition, and gesture understanding, among others. An example embodiment of the present disclosure extracts reliable features, such as facial landmarks or other features, from input images, such as the 2D image 106 of FIG. 1A, or any other input image. Such features are extracted with reduced parameters and computation cost relative to conventional neural networks.

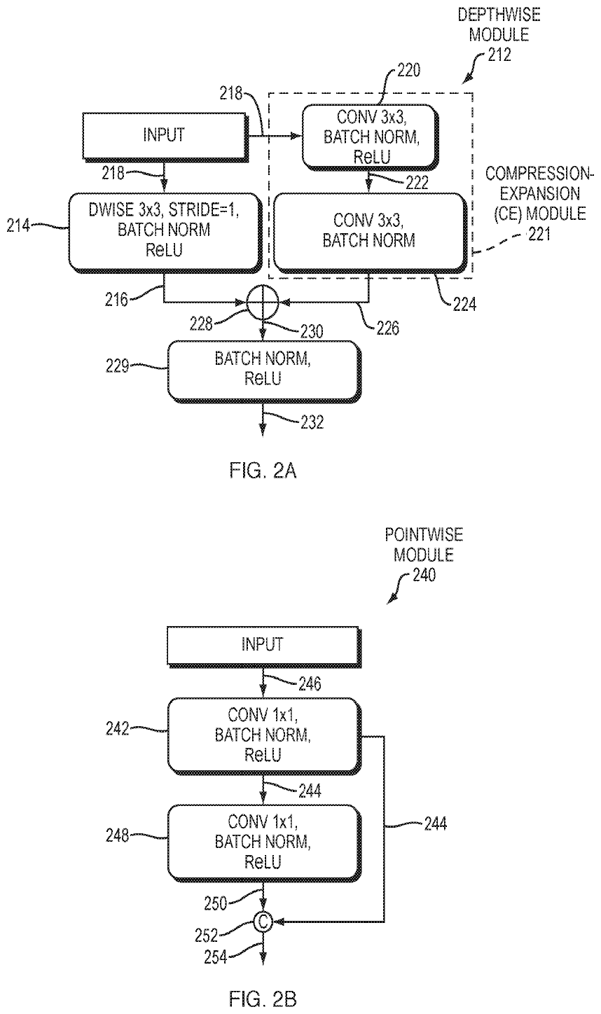

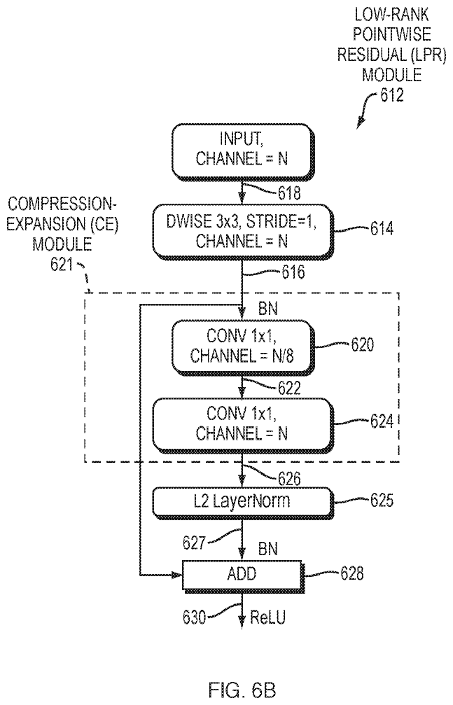

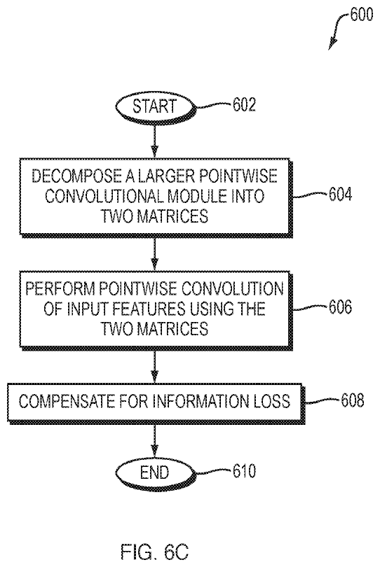

While attempts have been made to reduce parameters and computational cost of neural networks, such attempts have not satisfied the demand of the lightweight-for-mobile-applications that are based on face alignment. According to the example embodiment of FIG. 1A, the neural network includes at least one neural network element (not shown) that includes at least one compression-expansion (CE) module, such as the CE module 121 of FIG. 1B, the CE module 221 of FIG. 2A, or the CE module 621 of FIG. 6B, disclosed further below. The CE module includes two layers wherein a first layer compresses input feature maps with an original number of dimensions and the second layer expands the input feature maps compressed and outputs feature maps with the original number of dimensions. Such compression and expansion enables computational cost of a network element to be reduced.

The neural network includes an example embodiment of the neural network element that reduces computation and memory costs of the neural network as disclosed further below. Experiments on face alignment datasets and image classification datasets, disclosed further below, verify that example embodiments of the structure of the neural network element enable better overall performance than the state-of-the-art methods that do not employ same.

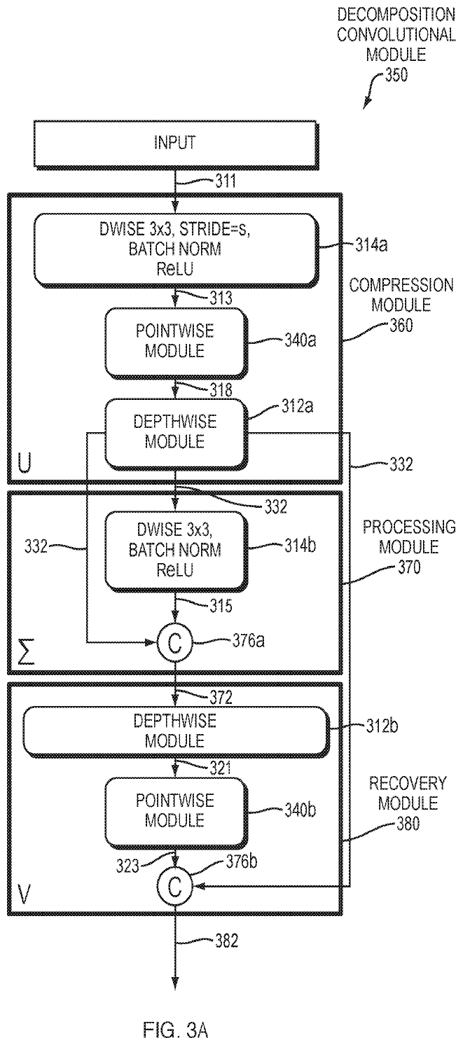

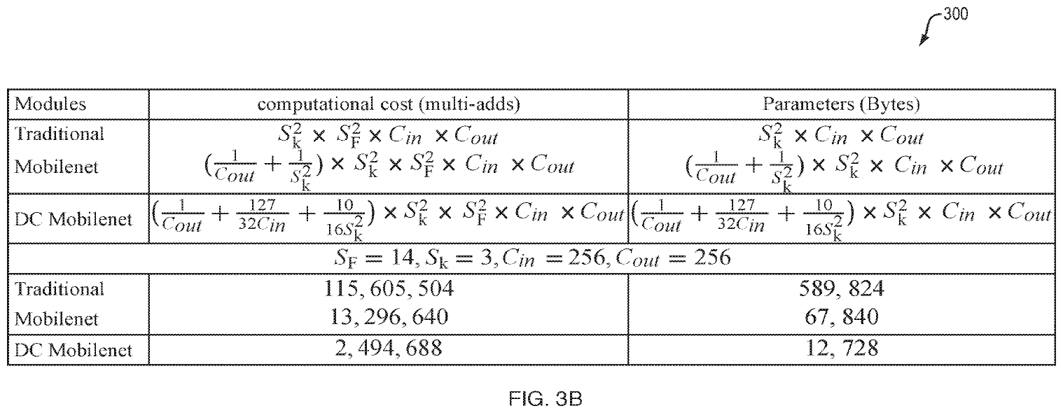

To decrease the computation and memory costs, an example embodiment of the CE module is employed in a convolutional structure that is based on the Singular Value Decomposition (SVD) principle, employs depthwise convolution and pointwise convolution, and is non-linear, such as disclosed further below with regard to FIG. 3A. Further, to avoid performance drop, an expansion tensor is computed from a fully convolved feature map and is added to feature maps output from a depthwise layer. To make a fair comparison with another neural network architecture, an architecture similar to Mobilenet (A. G. Howard, M. Zhu, B. Chen, D. Kalenichenko, W. Wang, T. Weyand, M. Andreetto, and H. Adam. Mobilenets: Efficient convolutional neural networks for mobile vision applications. arXiv preprint arXiv:1704.04861, 2017) was built with an example embodiment of a module disclosed herein. It is worth noting that example embodiments disclosed herein can be used on other more advanced network architectures that are more advanced relative to Mobilenet. Experiments on a face alignment task and image classification task were implemented and verify that an example embodiment of a structure disclosed herein has better overall performance than the state-of-the-art methods, as disclosed further below.

According to another example embodiment, to reduce the computation and memory costs, the CE module may compress a pointwise layer with low-rank style design. The CE module compresses computational costs and parameters using a small pointwise layer and recovers the dimension with a large pointwise layer. An example embodiment of a network element employing same may be referred to herein as a lightweight deep learning module by low-rank pointwise residual (LPR) convolution, an LPR module, LPRNet, or simply LPR.

LPR aims at using low-rank approximation in pointwise convolution to further reduce the module size, while keeping depthwise convolutions as the residual module to rectify information loss in the LPR module. This is useful when the low-rankness undermines the convolution process. Moreover, an example embodiment of LPR is quite general and can be applied directly to many existing network architectures, disclosed further below.

Experiments on visual recognition tasks including image classification and face alignment on popular benchmarks show that an example embodiment of LPRNet achieves competitive performance but with significant reduction of hardware flops and memory cost compared to the state-of-the-art deep lightweight models. An example embodiment of LPR is disclosed further below with regard to FIGS. 6A and 6B and may be employed as the network element 112, disclosed below with reference to FIG. 1B.

FIG. 1B is a block diagram of an example embodiment of a neural network 110. The neural network 110 may be employed by the application 107, disclosed above with regard to FIG. 1A. In the example embodiment of FIG. 1B, the neural network 100 comprises a neural network element 112. The neural network element 112 includes a depthwise convolutional layer 114 configured to output respective features 116 by performing spatial convolution of respective input features 118 having an original number of dimensions. The neural network element 112 further includes a first convolutional layer 120 configured to output respective features 122 as a function of respective input features 118. The respective features 122 output from the first convolutional layer 120 have a reduced number of dimensions relative to the original number of dimensions. The neural network element 112 further includes a second convolutional layer 124 configured to output respective features 126 as a function of the respective features 122 output from the first convolutional layer 120. The respective features 126 output from the second convolutional layer 124 have the original number of dimensions. The neural network element 112 further includes an add operator 128 configured to output respective features 130 as a function of the respective features 126 output from the second convolutional layer 124 and the respective features 116 output from the depthwise convolutional layer 114.

According to an example embodiment, the neural network 110 is a deep convolutional neural network (DCNN). The neural network 110 may be employed by an application to perform, on a mobile or embedded device, at least one of: face alignment, face synthesis, image classification, or pose estimation. It should be understood, however, that such application is not limited thereto and that the neural network 110 is not limited to being a DCNN or to being employed on a mobile or embedded device. According to an example, embodiment, the respective input features 118 to the first convolutional layer 114 may be the respective input features to the depthwise convolutional layer 114, as disclosed further below with regard to FIG. 2A.

In the example embodiment of FIG. 1B, the first convolutional layer 120, second convolutional layer 124, and depthwise convolutional layer 114 may be further configured to normalize, via batch normalization, the respective features output therefrom. The first convolutional layer 120 and depthwise convolutional layer 114 may be further configured to apply an activation function to the respective features normalized.

According to an example embodiment, the activation function is a rectified linear unit (ReLU) activation function configured to (i) output a given input feature, directly, in an event the given input feature has a positive value and (ii) output zero for the given input feature, otherwise. It should be understood that the activation function is not limited to a ReLU activation function. For example, the activation function may be a ReLU6 activation function, Swish activation function, or another non-linear activation function.

According to an example embodiment, a method of processing data, such as image data of the 2D image 106 disclosed above with regard to FIG. 1A or other data, may employ the neural network element 112 of FIG. 1B, as disclosed below with regard to FIG. 1C.

FIG. 1C is a flow diagram 1500 of an example a method of processing data in a neural network, such as the neural network 110 of FIG. 1B, disclosed above. In the example embodiment of FIG. 1C, the method begins (152) and outputs respective features from a depthwise convolutional layer of a network element, such as the neural network element 112 of FIG. 1B, as disclosed above, by performing spatial convolution of respective input features having an original number of dimensions (154). The method further outputs respective features from a first convolutional layer of the network element as a function of respective input features, the respective features output from the first convolutional layer having a reduced number of dimensions relative to the original number of dimensions (156). The method further outputs respective features from a second convolutional layer of the network element as a function of the respective features output from the first convolutional layer, the respective features output from the second convolutional layer having the original number of dimensions (158). The method further outputs respective features from an add operator of the network element as a function of the respective features output from the second convolutional layer and the respective features output from the depthwise convolutional layer (160). The method thereafter ends (162) in the example embodiment. The method may further comprise inputting the respective input features to the first convolutional layer to the depthwise convolutional layer, such as disclosed below with regard to FIG. 2A.

FIG. 2A is a block diagram of an example embodiment of a depthwise convolutional module 212. An example embodiment includes two novel modules: one is the depthwise module 212 and the other one is pointwise module 240, such as disclosed below with regard to FIG. 2B. These two modules are stacked as a basic structure following a matrix decomposition theory named Singular Value Decomposition (SVD), such as disclosed further below with regard to FIG. 3A. With references to FIG. 2A, the depthwise module 212 includes a depthwise convolutional layer 214 and a compression-expansion module (CE module) 221. According to an example embodiment, the CE module 221 includes two convolutional layers. The first convolutional layer 220 is employed to compress input feature maps 218 to one feature map using 3 by 3 convolution. The second convolutional layer 224 is employed to expand the one feature map to feature maps that have the same dimension as the input feature map 218. Then, output feature maps 226 from the second convolutional layer 224 are added to output feature maps 216 of the depthwise convolution layer 214 of the depthwise convolutional module 212.

The depthwise convolutional module 212 may be employed as the neural network element 112 of the neural network 110 of FIG. 1B, disclosed above. In the example embodiment of FIG. 2A, the neural network element, that is, the depthwise convolutional module 212, includes a depthwise convolutional layer 214 configured to output respective features 216 by performing spatial convolution of respective input features 218 having an original number of dimensions.

The depthwise convolutional module 212 further includes a first convolutional layer 220 configured to output respective features 222 as a function of respective input features 218. The respective input features 218 to the first convolutional layer 220 are the respective input features 218 to the depthwise convolutional layer 214. The respective features 222 output from the first convolutional layer 220 have a reduced number of dimensions relative to the original number of dimensions. The depthwise convolutional module 212 further includes a second convolutional layer 224 configured to output respective features 226 as a function of the respective features 222 output from the first convolutional layer 220. The respective features 226 output from the second convolutional layer 226 have the original number of dimensions. The first convolutional layer 220 in combination with the second convolutional layer 224 may be referred to herein as a compression-expansion (CE) module 221 because such layers, in combination, reduce a number of original dimensions of input features and then expand the number of original dimensions reduced back to the original number of dimensions. Such compression and expansion is performed to reduce computational cost, overall, as disclosed further below.

The depthwise convolutional module 212 further includes an add operator 228 configured to output respective features 230 as a function of the respective features 226 output from the second convolutional layer 224 and the respective features 216 output from the depthwise convolutional layer 214.

The first convolutional layer 220, second convolutional layer 224, and depthwise convolutional layer 214 may be further configured to normalize, via batch normalization, the respective features output therefrom. The first convolutional layer 220 and depthwise convolutional layer 214 may be further configured to apply an activation function to the respective features normalized. According to an example embodiment, the activation function is a rectified linear unit (ReLU) activation function configured to (i) output a given input feature, directly, in an event the given input feature has a positive value and (ii) output zero for the given input feature, otherwise. It should be understood, however, that the activation function is not limited to a ReLU activation function.

As disclosed herein, an activation function may be a non-linear activation function. For example, the activation function may be a ReLU activation function, such as ReLU6, or other ReLU activation function. It should be understood, however, that the non-linear activation function is not limited to a type of ReLU activation function. For example, the non-linear activation function may be a Swish activation function or other non-linear activation function.

The depthwise convolutional module 212 may further comprise an output processing layer 229 configured to output respective features 232 by normalizing, via batch normalization, the respective features 230 output from the add operator 228 and to apply an activation function to the respective features normalized. According to an example embodiment, at least one instance of the depthwise convolutional module 212 may be employed in a decomposition convolutional module, such as the decomposition convolutional module 350 of FIG. 3A, disclosed further below, in combination with at least one instance of a pointwise convolutional module, disclosed below with regard to FIG. 2B.

FIG. 2B is a block diagram of an example embodiment of a pointwise convolutional module 240. According to an example embodiment, the pointwise module 240 has two pointwise layers, a first pointwise layer 242 and a second pointwise layer 248. According to an example embodiment, the size of each pointwise layer is a quarter of the size of an original pointwise layer (not shown). A concatenate operation 252 is used to couple the two layers together as disclosed below.

According to an example embodiment, the neural network element 112 of FIG. 1i, disclosed above, further comprises the pointwise module 240. The pointwise module 240 includes a first pointwise convolutional layer 242 configured to output respective features 244 as a function of respective input features 246. The pointwise module 240 further includes a second pointwise convolutional layer 248 configured to output respective features 250 as a function of respective features 244 output from the first pointwise convolutional layer 242. The pointwise module 240 further includes a concatenator 252 configured to output respective features 254 by concatenating the respective features 244 output from the first pointwise convolutional layer 242 with the respective features 250 output from the second pointwise convolutional layer 248.

The first pointwise convolutional layer 242 and second pointwise convolutional layer 248 may be further configured to normalize, via batch normalization, the respective features output therefrom and to apply an activation function to the respective features normalized. According to an example embodiment, the pointwise module 240 may be employed with the depthwise module 212, disclosed above, in a decomposition convolutional module 350, disclosed below with regard to FIG. 3A.

FIG. 3A is a block diagram of an example embodiment of the decomposition convolutional module 350. The decomposition convolutional module 350 includes multiple instances of the depthwise convolutional module 212 of FIG. 2A and the pointwise convolutional module 240 of FIG. 2B. For example, in the example embodiment of FIG. 3A, the decomposition convolutional module 350 includes a first depthwise module 312a that is a first instance of the depthwise module 212 and a second depthwise module 312b that is a second instance of the depthwise module 212. Further, the decomposition convolutional module 350 includes a first pointwise module 340a that is a first instance of the pointwise module 240 and a second pointwise module 340b that is a second instance of the pointwise module 240b, as disclosed below.

Such instances of the depthwise module 212 and pointwise module 240 may be combined in the decomposition convolutional model 350 following the SVD principle as disclosed herein. Another two concatenate operations, namely the first concatenator 376a and second concatenator 376b, are added in the structure of the decomposition convolutional module 350 to increase the dimension of the feature maps without increasing the computation cost and parameters. Two residuals are added in a recovery module 380 of the decomposition convolutional module 350 to improve the performance.

With reference to FIGS. 1B, 2A, 2B, and 3A, the decomposition convolutional module 350 may be included in the neural network 110. The first depthwise module 312a, that is, the first instance of the depthwise module 212, may be employed as the neural network element 112 of the neural network 110. The first depthwise module 312a includes an instance of the depthwise convolutional layer 214. Such instance may be referred to as a first convolutional layer and is not shown in FIG. 3A.

The neural network 110 may include the decomposition convolutional module 350 and, as such, comprises a compression module 360 included in same. The compression module 360 is configured to output respective features 332 as a function of respective input features 311 that have the original number of dimensions. The compression module 360 includes a second depthwise convolutional layer 314a, the first pointwise module 340a, and the first depthwise module 312a. The respective features 332 output from the compression module 360 have the reduced number of dimensions.

The decomposition convolutional module 350 further includes a processing module 370, and, as such, the neural network 110 further comprises the processing module 370. The processing module 370 is configured to output respective features 372 as a function of the respective features 332 output from the compression module 360. The processing module 370 includes a third depthwise convolutional layer 314b and a first concatenator 376a.

The decomposition convolutional module 350 further includes a recovery module 380, and, as such, the neural network 110 further comprises the recovery module 380. The recovery module 380 is configured to output respective features 382 as a function of the respective features 372 output from the processing module 370. The recovery module 380 includes the second depthwise module 312b, second pointwise module 340b, and a second concatenator 376b. The respective features 382 output from the recovery module 380 have the original number of dimensions.

The second depthwise convolutional layer 314a is configured to output respective features 313 by performing spatial convolution of the respective input features 311 to the compression module 360. The first pointwise module 340a is configured to output respective features 318 as a function of the respective features 313 output from the second depthwise convolutional layer 314a. The first depthwise module 312a is configured to output respective features 332 as a function of the respective features 318 output from the first pointwise module 340a. The third depthwise convolutional layer 314b is configured to output respective features 315 as a function of the respective features 332 output from the first depthwise module 312a. The first concatenator 376a is configured to output respective features 372 by concatenating the respective features 332 output from the first depthwise module 312a with the respective features 315 output from the third depthwise convolutional layer 314b.

The second depthwise module 312b is configured to output respective features 321 as a function of the respective features 372 output from the first concatenator 376a. The second pointwise module 340b is configured to output respective features 323 as a function of the respective features 321 output from the second depthwise module 312b. The second concatenator 376b is configured to output respective features 382 from the recovery module 380 by concatenating the respective features 323 output from the second pointwise module 340b with the respective features 332 output from the first depthwise module 312a.

The second depthwise convolutional layer 314a and third depthwise convolutional layer 314b may be further configured to normalize, via batch normalization, the respective features output therefrom and may apply an activation function to the respective features normalized. Such an activation function may be a non-linear activation function. Further details regarding the architecture of the decomposition convolutional module 350 and motivation regarding same, are disclosed below.

The decomposition convolutional module 350 may be employed in a deep convolutional neural network (DCNN). Deep convolutional neural networks (DCNNS) have been widely used in many areas of machine intelligence, such as face synthesis (P. Dollar, P. Welinder, and P. Perona. Cascaded pose regres-sion. In CVPR, pages 1078-1085. IEEE, 2010), image classification (K. He, X. Zhang, S. Ren, and J. Sun. Deep residual learning for image recognition. In Proceedings of the IEEE conference on computer vision and pattern recognition, pages 770-778, 2016), pose estimation (Z. Cao, T. Simon, S.-E. Wei, and Y. Sheikh. Realtime multi-person 2d pose estimation using part affinity fields. In CVPR, 2017), etc. However, the time complexity and space complexity of deep convolution methods often go beyond the capabilities of many mobile and embedded devices (A. G. Howard, M. Zhu, B. Chen, D. Kalenichenko, W. Wang, T. Weyand, M. Andreetto, and H. Adam. Mobilenets: Efficient convolutional neural networks for mobile vision applications. arXiv preprint arXiv:1704.04861, 2017), M. Sandler, A. Howard, M. Zhu, A. Zhmoginov, and L.-C. Chen. Inverted residuals and linear bottlenecks: Mobile networks for classification, detection and segmentation. arXiv preprint arXiv:1801.04381, 2018), (X. Zhang, X. Zhou, M. Lin, and J. Sun. Shufflenet: An extremely efficient convolutional neural network for mobile devices. arXiv preprint arXiv:1707.01083, 2017).

Therefore, reducing the computational cost and storage size of deep networks is a useful and challenging task for further application. To drop the computational cost and parameters, a basic module named depthwise separable convolution was presented (L. Sifre and P. Mallat. Rigid-motion scattering for image classification. PhD thesis, Citeseer, 2014). Subsequently, many lightweight networks based on the module are demonstrated, such as Xception model (F. Chollet. Xception: Deep learning with depthwise separable convolutions. arXiv preprint, 2016), Squeezenet (F. N. Iandola, S. Han, M. W. Moskewicz, K. Ashraf, W. J. Dally, and K. Keutzer. Squeezenet: Alexnet-level accuracy with 50× fewer parameters and 0.5 mb model size. arXiv preprint arXiv:1602.07360, 2016), Mobilenet (A. G. Howard, M. Zhu, B. Chen, D. Kalenichenko, W. Wang, T. Weyand, M. Andreetto, and H. Adam. Mobilenets: Efficient convolutional neural networks for mobile vision applications. arXiv preprint arXiv:1704.04861, 2017), M. Sandler, A. Howard, M. Zhu, A. Zhmoginov, and L.-C. Chen. Inverted residuals and linear bottlenecks: Mobile networks for classification, detection and segmentation. arXiv preprint arXiv:1801.04381, 2018), Shufflenet (X. Zhang, X. Zhou, M. Lin, and J. Sun. Shufflenet: An extremely efficient convolutional neural network for mobile devices. arXiv preprint arXiv:1707.01083, 2017), etc. Although these networks have reduced the parameters and computational cost, they still cannot satisfy the demand of the lightweight for mobile applications based on face alignment.

In the work (V. Lebedev, Y. Ganin, M. Rakhuba, I. Oseledets, and V. Lempitsky. Speeding-up convolutional neural networks using fine-tuned cp-decomposition. arXiv preprint arXiv:1412.6553, 2014), the standard convolution operation is considered as a matrix operation. An example embodiment reduces parameters by decomposing the standard convolution into three parts following the principle of a conventional matrix dimension reduction method, Singular Value Decomposition (SVD). A theoretical explanation is disclosed further below with regard to Decomposition Convolution (DC) Mobilenet and provides reasoning for an example embodiment of a neural network element structure, disclosed further below with regard to FIG. 3A. Based on SVD theory, an m×n matrix can be decomposed into three matrices: an m×k matrix U, a k×k diagonal matrix E, and a k×n matrix V. According to an example embodiment, a neural network element structure referred to herein as a decomposition convolutional module 350, disclosed further below with regard to FIG. 3A, may include three parts: one pointwise module to reduce the dimension of the input tensor, a set of depthwise modules to process the spatial convolution in a large scale, followed thereafter by another pointwise module and a concatenate operation to recover the tensors' dimension.

An example embodiment discloses a Decompositional Convolution (DC) module that can reduce parameters by constructing a convolutional structure following SVD theory. An example embodiment discloses a Decompositional Convolution Mobilenet (DC-Mobilenet) reconstructed based on the Mobilenet with the Decompositional Convolution (DC) module. With DC-Mobilenet, the parameters are successfully reduced in magnitude (from MB to KB) compared with the traditional convolutional networks and the high performance is retained.

DC-Mobilenet was applied to a 3D face alignment task. On the most challenging datasets, an example embodiment of DC-Mobilenet obtained comparable results relative to state-of-the-art methods. Experimental results show that an example embodiment of DC-Mobilenet has a lower error rate (overall Normalized Mean Error is 2.89% on 68 points AFLW2000-3D [20, 2]), faster speed (78 FPS on one core CPU), and much smaller storage size (655 KB). Further, an example embodiment of DC-Mobilenets (both Mobilenetv1 and Mobilenetv2) was applied to an image classification task. On CIFAR-10, DC-Mobilenets disclosed herein obtained similar results as its baseline Mobilenet structure but employed less parameters.

Some methods have emerged that attempt to speed up the deep learning model. For example, a faster activation function named rectified-linear activation function (ReLU) was proposed to accelerate the model (X. Glorot, A. Bordes, and Y. Bengio. Deep sparse rectifier neural networks. In Proceedings of the Fourteenth Inter-national Conference on Artificial Intelligence and Statistics, pages 315-323, 2011). In (L. Sifre and P. Mallat. Rigid-motion scattering for image classification. PhD thesis, Citeseer, 2014), depthwise separable convolution was initially introduced and was used in Inception models (S. Ioffe and C. Szegedy. Batch normalization: Accelerating deep network training by reducing internal covariate shift. arXiv preprint arXiv:1502.03167, 2015), Xception network (F. Chollet. Xception: Deep learning with depthwise separa-ble convolutions. arXiv preprint, 2016), MobileNet (A. G. Howard, M. Zhu, B. Chen, D. Kalenichenko, W. Wang, T. Weyand, M. Andreetto, and H. Adam. Mobilenets: Efficient convolutional neural networks for mobile vision appli-cations. arXiv preprint arXiv:1704.04861, 2017), (M. Sandler, A. Howard, M. Zhu, A. Zhmoginov, and L.-C. Chen. Inverted residuals and linear bottlenecks: Mobile net-works for classification, detection and segmentation. arXiv preprint arXiv:1801.04381, 2018), and Shufflenet (X. Zhang, X. Zhou, M. Lin, and J. Sun. Shufflenet: An extremely efficient convolutional neural network for mobile devices. arXiv preprint arXiv:1707.01083, 2017). Jin et. al. (J. Jin, A. Dundar, and E. Culurciello. Flattened convolutional neural networks for feedforward acceleration. arXiv preprint arXiv:1412.5474, 2014) show the flattened CNN structure to accelerate the feedforward procedure. A Factorized Network (J. Jin, A. Dundar, and E. Culurciello. Flattened convolu-tional neural networks for feedforward acceleration. CoRR, abs/1412.5474, 2014) had the similar philosophy as well as the topological connection.

A compression method of a deep neural network was introduced in (J. Ba and R. Caruana. Do deep nets really need to be deep? In Advances in neural information processing systems, pages 2654-2662, 2014), indicating that sometimes complicated deep models could be equal in performance by small models. Then Hinton et al. extended the work in (G. Hinton, 0. Vinyals, and J. Dean. Distilling the knowledge in a neural network. arXiv preprint arXiv:1503.02531, 2015) with the weight transfer strategy. Squeezenet (F. N. Iandola, S. Han, M. W. Moskewicz, K. Ashraf, W. J. Dally, and K. Keutzer. Squeezenet: Alexnet-level accuracy with 50× fewer parameters and 0.5 mb model size. arXiv preprint arXiv:1602.07360, 2016) Combined such work with a fire module which has lots of 1×1 convolutional layers. Another strategy (M. Courbariaux, I. Hubara, D. Soudry, R. El-Yaniv, and Y. Bengio. Binarized neural networks: Training deep neu-ral networks with weights and activations constrained to +1 or −1. arXiv preprint arXiv:1602.02830, 2016), (M. Rastegari, V. Ordonez, J. Redmon, and A. Farhadi. Xnor-net: Imagenet classification using binary convolutional neu-ral networks. In European Conference on Computer Vision, pages 525-542. Springer, 2016) which converts the parameter from float type to binary type can compress the model significantly and achieve an impressive speed. However, the binarization would sacrifice some performance. According to an example embodiment disclosed herein and referred to as DC-Mobilenet, employs an SVD strategy in the convolutional structure to get better speed and compression ratio.

Decomposition Convolution Mobilenet (DC-Mobilenet)

In this section, an example embodiment of DC-Mobilenet for 3D face alignment is disclosed. First, the matrix explanation of depthwise separable convolution is disclosed. Second, the matrix explanation of an example embodiment of a structure is demonstrated. Third, an example embodiment of the architecture of DC-Mobilenet is disclosed. Denotations of symbols disclosed herein are disclosed in Table 1, below.

TABLE 1
Notations Summary

| Symbols | Denotations |
|---|---|
| S_{F} | The size of one feature map |
| Sₖ | The size of one kernel |
| Cᵢₙ | The number of input channels |
| Cₒᵤₜ | The number of output channels |
| Dᵢⱼ | The ᵢth weight for the ⱼth feature in Depthwise convolution |
| Pᵢⱼ | The ᵢth weight for the ⱼth feature in Pointwise convolution |
| Wᵢⱼ | The ᵢth weight for the ⱼth feature in standard convolution |
| ⊗ | Each element does Kronecker Product after matrix product |
| Fⱼ | The ⱼth feature map of the input |

Depthwise Separable Convolutions

Depthwise Separable Convolution layers are the keys for many lightweight neural networks (X. Zhang, X. Zhou, M. Lin, and J. Sun. Shufflenet: An extremely efficient convolutional neural network for mobile devices. arXiv preprint arXiv:1707.01083, 2017), (A. G. Howard, M. Zhu, B. Chen, D. Kalenichenko, W. Wang, T. Weyand, M. Andreetto, and H. Adam. Mobilenets: Efficient convolutional neural networks for mobile vision appli-cations. arXiv preprint arXiv:1704.04861, 2017), (M. Sandler, A. Howard, M. Zhu, A. Zhmoginov, and L.-C. Chen. Inverted residuals and linear bottlenecks: Mobile net-works for classification, detection and segmentation. arXiv preprint arXiv:1801.04381, 2018). It has two layers: depthwise convolutional layer and pointwise convolutional layer (A. G. Howard, M. Zhu, B. Chen, D. Kalenichenko, W. Wang, T. Weyand, M. Andreetto, and H. Adam. Mobilenets: Efficient convolutional neural networks for mobile vision appli-cations. arXiv preprint arXiv:1704.04861, 2017).

The depthwise convolutional layer applies a single convolutional filter to each input channel which will massively reduce the parameter and computational cost, which can be calculated as S_{F}×S_{F}×Sₖ×Sₖ×Cₒᵤₜ. Following the process of its convolution, the Depthwise convolution can be described using a matrix as:

$$[ \begin{matrix}{D}_{11} & 0 & . . . & 0 \\ 0 & {D}_{22} & . . . & 0 \\ ⋮ & ⋮ & ⋱ & ⋮ \\ 0 & 0 & … & {D}_{m m}\end{matrix} ] ⊗ {[ {F}_{1} {F}_{2} . . . {F}_{m} ]}^{T} \qquad ( 1 )$$

in which Dᵢⱼ is usually a 3×3 matrix, m is the number of the input feature maps.

The pointwise convolutional layer uses 1×1 convolution to build the new features through computing the linear combinations of all input channels. It is a type of conventional convolutional layer with the kernel size set as 1. The computational cost of the convolutional layer can be calculated as S_{F}×S_{F}×Cᵢₙ Cₒᵤₜ. Following the process of its convolution, the Pointwise convolution can be described using a matrix as:

$$[ \begin{matrix}{p}_{11} & {p}_{12} & . . . & {p}_{1 m} \\ {p}_{21} & {p}_{22} & . . . & {p}_{2 m} \\ ⋮ & ⋮ & ⋱ & ⋮ \\ {p}_{n 1} & {p}_{n 2} & . . . & {p}_{n m}\end{matrix} ] ⊗ {[ {F}_{1} {F}_{2} . . . {F}_{m} ]}^{T} \qquad ( 2 )$$

in which pᵢⱼ is a scalar, m is the number of the input feature maps, and n is the number of the output. The standard convolution can be written in the same format:

$$[ \begin{matrix}{W}_{11} & {W}_{12} & . . . & {W}_{1 m} \\ {W}_{21} & {W}_{22} & . . . & {W}_{2 m} \\ ⋮ & ⋮ & ⋱ & ⋮ \\ {W}_{n 1} & {W}_{n 2} & . . . & {W}_{n m}\end{matrix} ] ⊗ {[ {F}_{1} {F}_{2} . . . {F}_{m} ]}^{T} \qquad ( 3 )$$

The difference is Wᵢⱼ is a 3×3 matrix instead of a scalar.

Since the depthwise separable convolution is composed with depthwise convolution and pointwise convolution, it can be represented as:

$$[ \begin{matrix}{p}_{11} & . . . & {p}_{1 m} \\ ⋮ & ⋱ & ⋮ \\ {p}_{n 1} & . . . & {p}_{n m}\end{matrix} ] [ \begin{matrix}{D}_{11} & . . . & 0 \\ ⋮ & ⋱ & ⋮ \\ 0 & . . . & {D}_{m m}\end{matrix} ] ⊗ {[ {F}_{1} . . . {F}_{m} ]}^{T} \qquad ( 4 )$$

wherein P, D, and Ware defined as the matricies [pᵢⱼ], [Dᵢⱼ], and [Wᵢⱼ], respectively. Then the depthwise separable convolution can be explained in one equation:

W≈P×D (5)

Decomposition Convolutional Module

Similar to the depthwise separable convolution, the cores of the Decomposition Convolutional module include a Depthwise module and a Pointwise module. A concatenation is also used to expand the dimension. Detail settings of each module are introduced below followed by the calculation of the computational cost and parameters.

The depthwise module is constructed by one depthwise convolution and two standard convolutions as shown in FIG. 2A, disclosed above. According to an example embodiment, in addition to being passed to a depthwise convolutional layer, the input feature maps are convolved with 1 dimension 3×3 convolution layer. The following pointwise layer is used to recover the dimension. The aim of this module is to mix the features together with the least computational cost and may be expressed as:

$$[ \begin{matrix}{p}_{1} \\ ⋮ \\ {p}_{m}\end{matrix} ] [ {W}_{1} . . . {W}_{m} ] ⊗ {[ {F}_{1} ( 6 ) {F}_{m} ]}^{T} \qquad ( 6 )$$

With an add operation, each output feature from the depthwise convolutional layer will have the information from other features. An example embodiment of a whole process can be written as:

$$[ \begin{matrix}{D}_{11} + {p}_{1} {W}_{1} & {p}_{1} {W}_{2} & . . . & {p}_{1} {W}_{m} \\ {p}_{2} {W}_{1} & {D}_{22} + {p}_{2} {W}_{2} & . . . & {p}_{2} {W}_{m} \\ ⋮ & ⋮ & ⋱ & ⋮ \\ {p}_{m} {W}_{1} & {p}_{m} {W}_{2} & . . . & {D}_{mm} + {p}_{m} {W}_{m}\end{matrix} ] ⊗ {[ {F}_{1} {F}_{2} . . . {F}_{m} ]}^{T} \qquad ( 7 )$$

The computational cost of the depthwise module is 3×Sₖ²×S_{F}²×Cₒᵤₜ. To simplify the parameters calculation, no bias in the layer may be assumed, so the parameters amount is 3×Sₖ²×Cont.

The Pointwise Module, disclosed above with regard to FIG. 2B, aims to reduce the parameters while maintaining the features' property. Different from the standard pointwise convolutional layer, an example embodiment concatenates two small pointwise convolutions together as shown in FIG. 2B, disclosed above. In matrix format it can be represented as:

$$P ⊗ F \approx [ \begin{matrix}{P}_{1} \\ {P}_{2} {P}_{1}\end{matrix} ] ⊗ F \qquad ( 8 )$$

The row number of both P₁ and P₂ is half of the matrix P. The computational cost of the pointwise module is ½×S_{F}²×(Cᵢₙ+Cₒᵤₜ)×Cₒᵤₜ, and the parameter is ½×(Cᵢₙ+Cₒᵤₜ)×Cₒᵤₜ. In the meanwhile, the computational cost of the standard pointwise layer is S_{F}×Cᵢₙ×Cₒᵤₜ, and the parameter is Cᵢₙ×Cₒᵤₜ. Since in this module of an example embodiment of the framework, Cᵢₙ is always two times larger than Cₒᵤₜ, the parameters and computational cost can be significantly reduced by employing the example embodiment of the pointwise module.

The whole module, that is, the decomposition convolutional module 350 of FIG. 3A, disclosed above, is constructed following the Singular Value Decomposition (SVD) principle. Similar to Singular Value Decomposition, the whole module also can be decomposed into three parts as shown in FIG. 3A. The symbols U, Σ, and V are employed as the matrix representation of each part, namely, the compression module 360, the processing module 370, and recovery module 380, respectively. In the U part, the output channels will be the half of the input channels following the intuition of the dimension reduction using SVD. Assuming the number of input channels is m, it can be written as:

$${U}_{\frac{m}{2} m = {\overline{D}}_{\frac{m}{2} \frac{m}{2}}} [ \begin{matrix}{P}_{\frac{m}{4} m}^{1} \\ {P}_{\frac{m}{4} \frac{m}{4}}^{2} {P}_{\frac{m}{4} m}^{1}\end{matrix} ] {D}_{mm}^{1} \qquad ( 9 )$$

wherein Dₘₘ¹ is the matrix representation of the first Depthwise Convolution layer, P¹ is the matrix representation of the lth Pointwise Convolution layer in the Pointwise Module, and D̅ represents the Depthwise Module. According to an example embodiment, Σ includes a concatenate operation, namely the concatenator 376a, so that its input channels can be considered as a self-concatenate tensor. Thus, the matrix representation is:

$${Σ}_{m m} ⊗ [ \begin{matrix}{F}_{\frac{m}{2}} \\ {F}_{\frac{m}{2}}\end{matrix} ] = [ \begin{matrix}{{D}^{2}}_{\frac{m}{2} \frac{m}{2}} & 0 \\ 0 & {I}_{\frac{m}{2} \frac{m}{2}}\end{matrix} ] ⊗ [ \begin{matrix}{F}_{\frac{m}{2}} \\ {F}_{\frac{m}{2}}\end{matrix} ] \qquad ( 10 )$$

Since I is an identity matrix and D² is a diagonal matrix based on equation (1), disclosed above, Z is also a diagonal matrix. Therefore, Z is the fundamental module of the whole structure. In the V part, the dimension will be recovered by the concatenate operation instead of using a pointwise convolution to retain the low scale parameters. Since the input of this part also has m channels, the matrix representation is:

$${V}_{m m} = [ \begin{matrix}{P}_{\frac{m}{4} m}^{1} \\ {P}_{\frac{m}{4} \frac{m}{4}}^{2} {P}_{\frac{m}{4} m}^{1} \\ {W}_{\frac{m}{2} m}\end{matrix} ] [ {\overline{D}}_{m \frac{m}{2}}^{1} {\overline{D}}_{m \frac{m}{2}}^{2} ] \\ {W}_{\frac{m}{2} m} = {[ {0}_{\frac{m}{2} \frac{m}{2}} {I}_{\frac{m}{2} \frac{m}{2}} ] [ {\overline{D}}_{m \frac{m}{2}}^{1} {\overline{D}}_{m \frac{m}{2}}^{2} ]}^{- 1} \qquad ( 11 )$$

The total computational cost and parameters of the whole module, namely the decomposition convolutional module 350 can be computed. The result is shown in table 300 (also referred to interchangeably herein as Table 2) of FIG. 3B, disclosed below.

FIG. 3B is a table 300 of an example embodiment of comparison results on time and space complexity.

DC-Mobilenet Architecture

As disclosed above, an example embodiment of a neural network architecture may be referred to as DC-Mobilenet, which is constructed based on Mobilenetv1 and employs the decomposition convolutional module 350, disclosed above. The details of its architecture are disclosed below in Table 3.

TABLE 3
DC-Mobilenet Architecture

| Input | Operator | Stride | Kernels | output |
|---|---|---|---|---|
| 224² × 3 | conv2d1 | 2 | 3 × 3 | 112² × 16 |
| 112² × 16 | convdw2 | 1 | 3 × 3 | 112² × 16 |
| 112² × 16 | convpw3 | 1 | 1 × 1 | 112² × 32 |
| 112² × 32 | convdw4 | 2 | 3 × 3 | 56² × 32 |
| 56² × 32 | convpw5 | 1 | 1 × 1 | 56² × 32 |
| 56² × 32 | DC Module6 | 1 | — | 56² × 64 |
| 56² × 64 | DC Module7 | 2 | — | 28² × 64 |
| 28² × 64 | DC Module8 | 1 | — | 28² × 128 |
| 28² × 128 | DC Module9 | 2 | — | 14² × 256 |
| 14² × 256 | DC Module10 | 1 | — | 14² × 256 |
| 14² × 256 | DC Module11 | 1 | — | 14² × 256 |
| 14² × 256 | DC Module12 | 1 | — | 14² × 256 |
| 14² × 256 | DC Module13 | 1 | — | 14² × 256 |
| 14² × 256 | DC Module14 | 1 | — | 14² × 256 |
| 14² × 256 | DC Module15 | 2 | — | 7² × 512 |
| 7² × 512 | DC Module16 | 1 | — | 7² × 1024 |
| 7² × 1024 | convpw18 | 1 | 1 × 1 | 7² × class |
| 7² × class | avg pool | — | 7 × 7 | 1² × class |

Linear Regression Output

LPRNet: Lightweight Deep Network by Low-rank Pointwise Residual Convolution

As disclosed above, an example embodiment disclosed herein compresses a deep neural network and speeds up a model. Experiments on ImageNet and 3D Face Alignment disclosed herein show that an example embodiment of a model disclosed herein performs better than the state-of-the-art methods.

According to an example embodiment, a module compresses the pointwise layer with low-rank style design. The module compresses computational costs and parameters using a small pointwise layer and recovers the dimension with a large pointwise layer. The module retains the performance using Residual and L2 LayerNorm.

An example embodiment of the module can be applied to other models for speed up and parameters reduction. The module can be utilized for lightweight architecture. The module can construct accurate image classification models. This approach provides accurate 3D facial landmarks. Example embodiments disclosed herein can be applied to compress models that are heavy for the mobile devices. Example embodiments disclosed herein can be applied to many applications, such as pose estimation, face recognition, image classification, etc.

An example embodiment disclosed herein extracts reliable features from input images. The example embodiment includes three layers. The first layer is a depthwise layer, which can convolve the inputs and extract the spatial features. The second layer is a small pointwise layer. It is utilized to reduce the channel-wise dimension of the features from the depthwise layer. After the small pointwise layer, a large pointwise layer is used to recover the channel dimension of the features. These two layers are designed following the low-rank decomposition theory. After the channel expansion, a layer-normalization is added to further enhance the communication among the features. Further, a residual module is applied to recover the rank of the weight matrix and retain the performance. At the end of the depthwise and the layer normalization, batch normalizations are used to unify the scale of the features. Thereafter, a Rectified Linear Unit (ReLU) is used as an activation function. It should be understood, however, that the activation function is not limited to a ReLU activation function.

As disclosed above, deep learning has become popular in recent years primarily due to powerful computing devices, such as a GPU. However, it is challenging to deploy these deep models to end-user devices, smart phones, or embedded systems with limited resources. To reduce the computation and memory costs, an example embodiment of a network element is disclosed. An example embodiment of the network element may be referred to as a lightweight deep learning module by low-rank pointwise residual (LPR) convolution, or simply, LPRNet or LPR. LPR aims at using low-rank approximation in pointwise convolution to further reduce the module size, while keeping depthwise convolutions as the residual module to rectify the LPR module. This is useful when the low-rankness undermines the convolution process. Moreover, an example embodiment of LPR is quite general and can be applied directly to many existing network architectures, such as MobileNetv1, ShuffleNetv2, MixNet, etc. Experiments on visual recognition tasks including image classification and face alignment on popular benchmarks show that an example embodiment of LPRNet achieves competitive performance but with significant reduction of hardware flops and memory cost compared to the state-of-the-art deep lightweight models.

Deep convolutional neural networks (DCNN) have been widely used in many areas of machine learning and computer vision, such as face synthesis (Piotr Dollir, Peter Welinder, and Pietro Perona. Cascaded pose regression. In CVPR, pages 1078-1085, 2010), image classification (Kaiming He, Xiangyu Zhang, Shaoqing Ren, and Jian Sun. Deep residual learning for image recognition. In CVPR, pages 770-778, 2016), pose estimation (Zhe Cao, Tomas Simon, Shih-En Wei, and Yaser Sheikh. Realtime multi-person 2d pose estimation using part affinity fields. In CVPR, 2017), and many more. However, the model complexity of DCNN in terms of time and space makes it hard for direct applications on mobile and embedded devices (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018), (Xiangyu Zhang, Xinyu Zhou, Mengxiao Lin, and Jian Sun. Shufflenet: An extremely efficient convolutional neural network for mobile devices. In CVPR, 2018), (Ningning Ma, Xiangyu Zhang, Hai-Tao Zheng, and Jian Sun. Shufflenet v2: Practical guidelines for efficient cnn architecture design. In ECCV, pages 122-138, 2018).

Therefore, it is useful to design dedicated DCNN modules to reduce the computational cost and storage size for further applications on end devices. Furthermore, to make full use of existing networks, a general and efficient module is useful to replace the standard convolution module without changing the architectures.

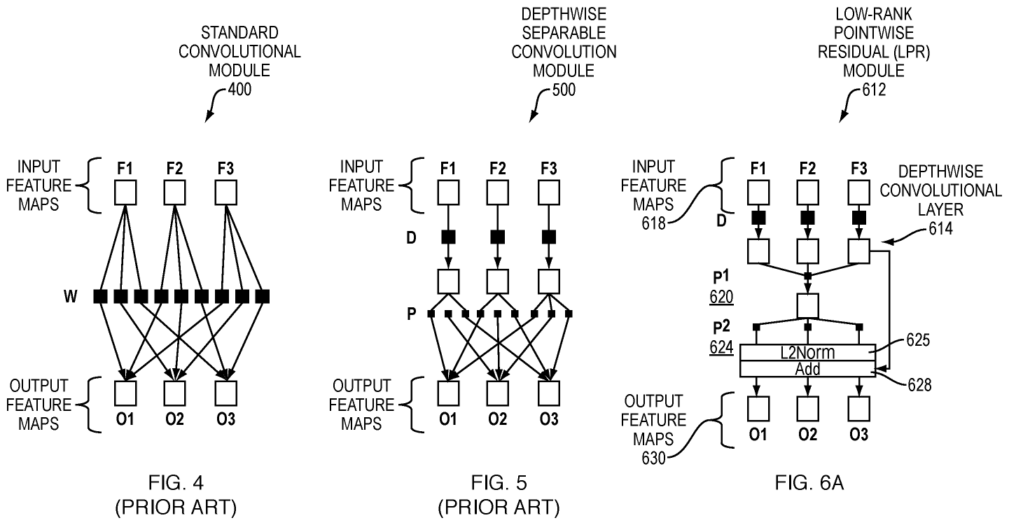

FIG. 4 is a block diagram of a prior art standard convolutional module 400. Additional disclosure regarding standard convolution is disclosed further below. The standard convolution operation in FIG. 4 includes a large number of parameters (i.e., nmk², where k≥3 is the size of filters, n and m are the numbers of output and input feature channels or maps), which results in a high time and space complexity. To reduce the complexities, the standard convolution is divided into depthwise and pointwise convolutions, namely, depthwise separable convolution (DSC) (Laurent Sifre and P S Mallat. Rigid-motion scattering for image classification. PhD thesis, Citeseer, 2014), (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017) as disclosed in FIG. 5, below.

FIG. 5 is a block diagram a prior art depthwise separable convolutional (DSC) module 500. Additional disclosure regarding DSC is disclosed further below. Based on the DSC module, many lightweight networks are demonstrated, such as Xception model (Francois Chollet. Xception: Deep learning with depthwise separable convolutions. In CVPR, pages 1251-1258, 2017), SqueezeNet (Forrest N Iandola, Song Han, MatthewWMoskewicz, Khalid Ashraf, William J Dally, and Kurt Keutzer. Squeezenet: Alexnet-level accuracy with 50× fewer parameters and <0.5 mb model size. ICLR, 2017), MobileNet (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018), ShuffleNet (Xiangyu Zhang, Xinyu Zhou, Mengxiao Lin, and Jian Sun. Shufflenet: An extremely efficient convolutional neural network for mobile devices. In CVPR, 2018), (Ningning Ma, Xiangyu Zhang, Hai-Tao Zheng, and Jian Sun. Shufflenet v2: Practical guidelines for efficient cnn architecture design. In ECCV, pages 122-138, 2018). In fact, the depthwise convolution applies a single filter to each input channel, and the pointwise convolution only uses 1×1 filters to compute the output features. Thus, the number of the parameters in the DSC module is significantly reduced to mk²+nm. It should be noted that most of the popular DCNN models still use a large number of channels (i.e., large m and n) for better performance. Therefore, the pointwise convolution in DSC or relevant models still suffer from the higher time and space complexity. In addition, some modules, such as MobileNetv2, cannot fit into the existing networks without changing their architectures. Thus, a lighter model targeting at these problems may promote the deployment of more DCNNs to mobile applications.

To address the above-noted problems, an example embodiment of a novel DCNN parameters reduction module is introduced. An example embodiment may be based on the principle of the low-rank CP-decomposition method (Max Jaderberg, Andrea Vedaldi, and Andrew Zisserman. Speeding up convolutional neural networks with low rank expansions. In BMVC, 2014), (Vadim Lebedev, Yaroslav Ganin, Maksim Rakhuba, Ivan Oseledets, and Victor Lempitsky. Speeding-up convolutional neural networks using fine-tuned cp-decomposition. ICLR, 2015). Instead of decomposing learned weight matrices, however, an example embodiment may apply the CP-decomposition on the layer design. In addition to decomposing the conventional full-channel convolution into depthwise and pointwise convolutions, an example embodiment develops new learning paradigms for each of them and, thus, reduces the overall model complexity. An example embodiment employs low-rank matrix decomposition and divides the large pointwise convolution into two small low-rank pointwise convolutions, as shown in FIG. 6A, disclosed below.

FIG. 6A is a block diagram of an example embodiment of the present invention of a low-rank pointwise residual (LPR) module 612. As disclosed in FIG. 6A, the LPR module 612 has divided the large pointwise convolution into two small low-rank pointwise convolutions. When its rank is r<n, m, the number of the parameters is further reduced to mk²+(n+m)r. Furthermore, to compensate for the low-rankness of pointwise convolution and performance recession due to this compression, a residual operation through depthwise convolution is implemented to complement the feature maps without any additional parameters. Further details regarding the LPR module 612 are disclosed below with reference to FIG. 6B.

FIG. 6B is a more detailed block diagram of the example embodiment of the LPR module 612 of FIG. 6A. The LPR module 612 may be employed as the neural network element 112 of FIG. 1B, disclosed above. The LPR module 612 includes a depthwise convolutional layer 614 configured to output respective features 616 by performing spatial convolution of respective input features 618 having an original number of dimensions. The LPR module 612 further includes first convolutional layer 620 configured to output respective features 622 as a function of respective input features, namely, the respective features 616 that are output from the depthwise convolutional layer 616. The respective features 622 output from the first convolutional layer 620 have a reduced number of dimensions relative to the original number of dimensions. The LPR module 612 further includes a second convolutional layer 624 configured to output respective features 626 as a function of the respective features 622 output from the first convolutional layer 620. The respective features 626 output from the second convolutional layer 624 have the original number of dimensions. The LPR module 612 further includes an add operator 628 configured to output respective features 630 as a function of the respective features 626 output from the second convolutional layer 624 and the respective features 616 output from the depthwise convolutional layer 614.

The depthwise convolutional layer 614 may be further configured to normalize, via batch normalization (BN), the respective features 616 output therefrom. The LPR module 612 may further comprise an L2 normalization layer 625 configured to output respective features 627 by applying L2 normalization to the respective features 626 output from the second convolutional layer 624. The LPR module 612 may be further configured to batch normalize (BN) the respective features 627 output from the L2 normalization layer 625. The add operator 628 is further configured to output the respective features 630 by adding (i) the respective feature maps 626 output from the second convolutional layer 624, normalized by the L2 normalization layer 625, and batch normalized and (ii) the respective feature maps 616 output from the depthwise convolutional layer 614.

The LPR module 612 may be further configured to apply an activation function to the respective features 630 output from the add operator 628. The activation function may be a non-linear activation function, such as a ReLU6 or Swish activation function, or other non-linear activation function.

The LPR module 612 may be constructed by decomposing a larger pointwise convolution module (not shown) into two low-rank matrices through network learning, the two low-rank matrices employed by the first convolutional layer 620 and second convolutional layer 624, which significantly reduces the computational consumption of a neural network, such as the neural network 110 of FIG. 1A. According to an example embodiment, the first convolutional layer 620 and second convolutional layer 624 perform pointwise convolution. A residual learning mechanism may be implemented to compensate for information loss in pointwise convolution due to the matrix low-rankness, which guarantees the performance of the lightweight model, that is, the LPR module 612, without additional cost, as disclosed further below. The residual learning mechanism may include applying L2 layer normalization, such as disclosed above with regard to FIG. 6B, and below with regard to FIG. 6C.

FIG. 6C is a flow diagram 600 of another example embodiment of the invention in which a method processes data in a neural network. The method begins (602) and decomposes a larger pointwise convolutional module into two matrices through network learning in the neural network, the larger pointwise convolutional module being larger relative to the two matrices (604). The method performs pointwise convolution of input features using the two matrices and compensates for information loss in output features produced via the pointwise convolution performed, the compensating including applying residual learning to the output features (608). The method thereafter ends (610) in the example embodiment. According to an example embodiment, applying residual learning includes applying L2 normalization. Further details regarding same are disclosed below.

To demonstrate the generality and performance of an example embodiment of a method on model compression, an example embodiment of the model was applied to both MobileNet and ShuffleNetv2, and SOTA auto-searched network MixNet, and obtained promising results.

An example embodiment of the LPR module was embedded in the network structure of MobileNet and ShuffleNetv2, and validated that employing an example embodiment of the LPR module can significantly reduce the parameters and hardware flops employed while keeping the performance with the same architecture. Additionally, an example embodiment of the LPR module was employed in an auto-searched network called MixNet with several modifications and still achieved comparable results.

Correctness on image classification and face alignment tasks employing an example embodiment of the LPR module was also validated. On ImageNet dataset, while using much smaller parameters compared to the state-of-the-art, very competitive performance was achieved employing an example embodiment of the LPR module. On challenging face alignment benchmarks, an example embodiment of LPRNet obtained comparable results.

A review of related work on lightweight network construction follows below. Then an overview of the state-of-the-art on image classification is given. Further, some related work on face alignment is also presented.

Deep Lightweight Structure

As disclosed above, some methods have emerged for speeding up the deep learning model. A faster activation function named rectified-linear activation function (ReLU) was proposed to accelerate the model (Xavier Glorot, Antoine Bordes, and Yoshua Bengio. Deep sparse rectifier neural networks. In AISTATS, pages 315-323, 2011). Jin et al. (Jonghoon Jin, Aysegul Dundar, and Eugenio Culurciello. Flattened convolutional neural networks for feedforward acceleration. CoRR, 2014) show the flattened CNN structure to accelerate the feedforward procedure. In (Laurent Sifre and P S Mallat. Rigid-motion scattering for image classification. PhD thesis, Citeseer, 2014) depthwise separable convolution was initially introduced and was used in Inception models (Sergey Ioffe and Christian Szegedy. Batch normalization: Accelerating deep network training by reducing internal covariate shift. ICML, 2015), Xception network (Francois Chollet. Xception: Deep learning with depthwise separable convolutions. In CVPR, pages 1251-1258, 2017), MobileNet (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018), and ShuffleNet (Xiangyu Zhang, Xinyu Zhou, Mengxiao Lin, and Jian Sun. Shufflenet: An extremely efficient convolutional neural network for mobile devices. In CVPR, 2018), (Ningning Ma, Xiangyu Zhang, Hai-Tao Zheng, and Jian Sun. Shufflenet v2: Practical guidelines for efficient cnn architecture design. In ECCV, pages 122-138, 2018), condensenet (Gao Huang, Shichen Liu, Laurens van der Maaten, and Kilian Q. Weinberger. Condensenet: An efficient densenet using learned group convolutions. In CVPR, June 2018).

In addition to designing architectures manually, implementing a network to search CNN architectures was another significant method. Many networks are searched by methods automatically, such as Darts (Hanxiao Liu, Karen Simonyan, and Yiming Yang. Darts: Differentiable architecture search. In ICLR, 2019), NasNet (Barret Zoph, Vijay Vasudevan, Jonathon Shlens, and Quoc V Le. Learning transferable architectures for scalable image recognition. In CVPR, pages 8697-8710, 2018), PNasNet (Chenxi Liu, Barret Zoph, Maxim Neumann, Jonathon Shlens, Wei Hua, Li-Jia Li, Li Fei-Fei, Alan Yuille, Jonathan Huang, and Kevin Murphy. Progressive neural architecture search. In ECCV, pages 19-34, 2018), ProxylessNas (Han Cai, Ligeng Zhu, and Song Han. Proxylessnas: Direct neural architecture search on target task and hardware. In ICLR, 2019), FBNet (Bichen Wu, Xiaoliang Dai, Peizhao Zhang, Yanghan Wang, Fei Sun, Yiming Wu, Yuandong Tian, Peter Vajda, Yangqing Jia, and Kurt Keutzer. Fbnet: Hardware-aware efficient con-vnet design via differentiable neural architecture search. In CVPR, pages 10734-10742, 2019), MNasNet (Mingxing Tan, Bo Chen, Ruoming Pang, Vijay Vasudevan, and Quoc V Le. Mnasnet: Platform-aware neural architecture search for mobile. In CVPR, 2019), MobileNetv3 (Andrew Howard, Mark Sandler, Grace Chu, Liang-Chieh Chen, Bo Chen, Mingxing Tan, Weijun Wang, Yukun Zhu, Ruoming Pang, Vijay Vasudevan, et al. Searching for mo-bilenetv3. In ICCV, 2019), and MixNet (Mingxing J Tan and Quoc V Le. Mixnet: Mixed depthwise convolutional kernels. In BMVC, 2019). They further pushed the state-of-the-art performance with less FLOPs and parameters.

Low-rank methods are another way to make lightweight models. Group Lasso (Ming Yuan and Yi Lin. Model selection and estimation in regression with grouped variables. Journal of the Royal Statistical Society: Series B (Statistical Methodology), 68(1):49-67, 2006) is an efficient regularization for learning sparse structures. Jaderberg et al. (Max Jaderberg, Andrea Vedaldi, and Andrew Zisserman. Speeding up convolutional neural networks with low rank expansions. In BMVC, 2014) implemented the low-rank theory on the weights of filters with separate convolution in different dimensions. In 2017, an architecture termed SVDNet (Yifan Sun, Liang Zheng, Weijian Deng, and Shengjin Wang. Svdnet for pedestrian retrieval. ICCV, 2017) also considered matrix low-rankness in their framework to optimize the deep representation learning process. IGC (Ting Zhang, Guo-Jun Qi, Bin Xiao, and Jingdong Wang. Interleaved group convolutions. In ICCV, pages 4373-4382, 2017), (Guotian Xie, Jingdong Wang, Ting Zhang, Jianhuang Lai, Richang Hong, and Guo-Jun Qi. Interleaved structured sparse convolutional neural networks. In CVPR, June 2018), (Ke Sun, Mingjie Li, Dong Liu, and Jingdong Wang. Igcv3: Interleaved low-rank group convolutions for efficient deep neural networks. 2018) utilized grouped pointwise convolution to factorize the weight matrices as block matrices. Different from IGC, an example embodiment of LPRNet employs a low dimension pointwise layer to compress the model. In addition, and example embodiment of LPRNet recovers the information loss with residual from the depthwise layer and L2 layer normalization.

Image Classification

Image classification has been extensively used to evaluate the performance of different deep learning models. For example, small-scale datasets (Alex Krizhevsky and Geoffrey Hinton. Learning multiple layers of features from tiny images. Technical report, Citeseer, 2009) and large-scale datasets (Jia Deng, Wei Dong, Richard Socher, Li-Jia Li, Kai Li, and Li Fei-Fei. Imagenet: A large-scale hierarchical image database. In CVPR, pages 248-255, 2009), (Jia Deng, Wei Dong, Richard Socher, Li-Jia Li, Kai Li, and Li Fei-Fei. Imagenet: A large-scale hierarchical image database. In CVPR, pages 248-255, 2009) are often adopted as benchmarks in state-of-the-art works. In 2012, AlexNet was invented and considered as the first breakthrough DCNN model on ImageNet (Alex Krizhevsky, Ilya Sutskever, and Geoffrey E Hinton. Imagenet classification with deep convolutional neural networks. In NIPS, pages 1097-1105, 2012). Simonyan et al. later presented a deep network called VGG (Karen Simonyan and Andrew Zisserman. Very deep convolutional networks for large-scale image recognition. ICLR, 2015), which further boosted the state-of-the-art performance on ImageNet. GoogLeNet (Christian Szegedy, Wei Liu, Yangqing Jia, Pierre Sermanet, Scott Reed, Dragomir Anguelov, Dumitru Erhan, Vincent Vanhoucke, and Andrew Rabinovich. Going deeper with convolutions. In CVPR, pages 1-9, 2015) presented better results via an even deeper architecture. What followed is the widely adopted deep structure termed ResNet (Kaiming He, Xiangyu Zhang, Shaoqing Ren, and Jian Sun. Deep residual learning for image recognition. In CVPR, pages 770-778, 2016), which enabled very deep networks and presented the state-of-the-art in 2016. Huang et al. further improved ResNet by densely using residuals in different layers. called DensenNet (Gao Huang, Zhuang Liu, Laurens Van Der Maaten, and Kilian Q Weinberger. Densely connected convolutional networks. In CVPR, 2017) and improved the performance on ImageNet in 2017. Inception-v4 (Christian Szegedy, Sergey Ioffe, Vincent Vanhoucke, and Alexander A Alemi. Inception-v4, inception-resnet and the impact of residual connections on learning. In AAAI, volume 4, page 12, 2017) is a structure that embraces the merits of both ResNet and GoogLeNet. An example embodiment of LPRNet is developed based on low-rank matrix decomposition and, in addition, a residual term is used to compensate for information loss due to compression. Most importantly, it retains the performance while reducing the parameters and computational burden.

Face Alignment

In conventional face alignment works, patch-based regression methods were widely discussed (Timothy F Cootes, Christopher J Taylor, David H Cooper, and Jim Graham. Active shape models-their training and application. CVU, 61(1):38-59, 1995), (Tadas Baltrusaitis, Peter Robinson, and Louis-Philippe Morency. 3d constrained local model for rigid and non-rigid facial tracking. In CVPR, pages 2610-2617, 2012), (Timothy F. Cootes, Gareth J. Edwards, and Christopher J. Taylor. Active appearance models. TPAMI, 23(6):681-685, 2001), (Tadas Baltrusaitis, Peter Robinson, and Louis-Philippe Morency. Openface: an open source facial behavior analysis toolkit. In WACV, pages 1-10, 2016) in past decades. In addition, tree-based methods (Vahid Kazemi and Josephine Sullivan. One millisecond face alignment with an ensemble of regression trees. In CVPR, pages 1867-1874, 2014), (Shaoqing Ren, Xudong Cao, Yichen Wei, and Jian Sun. Face alignment at 3000 fps via regressing local binary features. In CVPR, pages 1685-1692, 2014) with plain features attracted more attention and achieved high-speed alignment. Based on optimization theory, a cascade of weak regressors was implemented for face alignment (Xuehan Xiong and Fernando De la Torre. Supervised descent method and its applications to face alignment. In CVPR, pages 532-539, 2013).

Along with the rise of deep learning, Sun et al. (Yi Sun, Xiaogang Wang, and Xiaoou Tang. Deep convolutional network cascade for facial point detection. In CVPR, pages 3476-3483, 2013) firstly utilized CNN model for face alignment with a face image as the input to CNN module, followed by regression on high-level features. It spawned considerable deep models (George Trigeorgis, Patrick Snape, Mihalis A Nico-laou, Epameinondas Antonakos, and Stefanos Zafeiriou. Mnemonic descent method: A recurrent process applied for end-to-end face alignment. In CVPR, pages 4177-4187, 2016), (Yaojie Liu, Amin Jourabloo, William Ren, and Xiaoming Liu. Dense face alignment. ICCV Workshop, 2017), (Xiangyu Zhu, Zhen Lei, Xiaoming Liu, Hailin Shi, and Stan Z Li. Face alignment across large poses: A 3d solution. In CVPR, pages 146-155, 2016), (Bin Sun, Ming Shao, Si-Yu Xia, and Yun Fu. Deep evolutionary 3d diffusion heat maps for large-pose face alignment. In BMVC, 2018), (Chandrasekhar Bhagavatula, Chenchen Zhu, Khoa Luu, and Marios Savvides. Faster than real-time facial alignment: A 3d spatial transformer network approach in unconstrained poses. ICCV, 2, 2017), (Rajeev Ranjan, Vishal M Patel, and Rama Chellappa. Hyper-face: A deep multi-task learning framework for face detection, landmark localization, pose estimation, and gender recognition. TPAMI, 2017), (Amit Kumar and Rama Chellappa. Disentangling 3d pose in a dendritic cnn for unconstrained 2d face alignment. CVPR, 2018) that achieved good results on large pose face alignment. Besides, recently published large pose face alignment datasets with 3D warped faces for large poses (Xiangyu Zhu, Zhen Lei, Xiaoming Liu, Hailin Shi, and Stan Z Li. Face alignment across large poses: A 3d solution. In CVPR, pages 146-155, 2016), or DNN structure Glass (Jing Yang, Qingshan Liu, and Kaihua Zhang. Stacked hour-glass network for robust facial landmark localisation. In CVPR Workshop, pages 2025-2033, 2017), (Adrian Bulat and Georgios Tzimiropoulos. How far are we from solving the 2d & 3d face alignment problem? (and a dataset of 230,000 3d facial landmarks). In ICCV, pages 1021-1030, 2017) have significantly promoted the development and benchmarks in this field. An example embodiment of LPRNet is also evaluated herein on the large-pose face alignment problem to show its effectiveness and efficiency on the regression tasks.

LPRNet

An example embodiment of LPRNet is further disclosed. First, the standard convolution (Karen Simonyan and Andrew Zisserman. Very deep convolutional networks for large-scale image recognition. ICLR, 2015) and depthwise separable convolution from a matrix product perspective (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017) is introduced. Next, an example embodiment of an LPR structure is disclosed and employed as a building block in LPRNet. Further disclosure and experimental results obtained using an example embodiment of LPRNet are also disclosed. Notations employed below have been summarized in Table 1, disclosed above.

Standard Convolutions (SConv)

In traditional DCNNs, the convolution operation is applied between each filter and the input feature map. Essentially, the filter applies different weights to different features while performing convolution. Afterward, all features convoluted by one filter are be added together to generate a new feature map. The whole procedure is equivalent to a series of matrix products, which can be formally written as:

$$[ \begin{matrix}{W}_{11} & . . . & {W}_{1 m} \\ ⋮ & ⋱ & ⋮ \\ {W}_{n 1} & . . . & {W}_{n m}\end{matrix} ] ⊗ {[ {F}_{1} {F}_{2} . . . {F}_{m} ]}^{T} \qquad ( 12 )$$

wherein Wᵢⱼ is the weight of the i-th filter corresponding to the j-th feature map, F is the input feature map, and Wᵢⱼ⊗Fⱼ means the feature map Fⱼ is convoluted by filter with the weight Wᵢⱼ. As disclosed herein, each Wᵢⱼ is a 3×3 matrix (filter), and all of them constitute a large matrix [Wᵢⱼ], or simply W. It should be understood, however, that Wᵢⱼ is not limited to a 3×3 matrix.

Depthwise Separable Convolution (DSC)

Depthwise Separable Convolution layers are the keys to many lightweight neural networks (Xiangyu Zhang, Xinyu Zhou, Mengxiao Lin, and Jian Sun. Shufflenet: An extremely efficient convolutional neural network for mobile devices. In CVPR, 2018), (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018). It has two layers: the depthwise convolutional layer and the pointwise convolutional layer (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017).

Depthwise convolutional layer applies a single convolutional filter to each input channel, which will massively reduce the parameter and computational cost. Following the process of its convolution, the depthwise convolution can be represented in the form of matrix product:

$$[ \begin{matrix}{D}_{11} & . . . & 0 \\ ⋮ & ⋱ & ⋮ \\ 0 & . . . & {D}_{m m}\end{matrix} ] ⊗ {[ {F}_{1} {F}_{2} . . . {F}_{m} ]}^{T} \qquad ( 13 )$$

in which Dᵢⱼ is usually a 3×3 matrix, and m is the number of the input feature maps. As disclosed herein, D is defined as the matrix [Dᵢⱼ]. Since D is a diagonal matrix, the depthwise layer has much less parameters than a standard convolution layer.

Pointwise convolutional layer uses 1×1 convolution to build the new features through computing the linear combinations of all input channels. It follows the fashion of traditional convolution layer with the kernel size set to 1. Following the process of its convolution, the pointwise convolution can be described in the form of matrix products:

$$[ \begin{matrix}{p}_{11} & . . . & {p}_{1 m} \\ ⋮ & ⋱ & ⋮ \\ {p}_{n 1} & . . . & {p}_{n m}\end{matrix} ] ⊗ {[ {F}_{1} {F}_{2} . . . {F}_{m} ]}^{T} \qquad ( 14 )$$

in which pᵢⱼ is a scalar, m is the number of the input feature maps, and n is the number of the output. The computational cost is S_{F}×S_{F}×Cᵢₙ×Cₒᵤₜ, and the number of parameters is Cᵢₙ×Cₒᵤₜ. According to an example embodiment, P∈R^{m×n} is defined as the matrix [pᵢⱼ]. Since the depthwise separable convolution is composed with depthwise convolution and pointwise convolution, it can be represented as:

F^{out}=W⊗Fⁱⁿ≈(PD)⊗Fⁱⁿ (15)

The output features of the pointwise layer, including batch normalization (BN) layer and activate function (usually ReLU), are generally sparse in the MobileNet architecture.

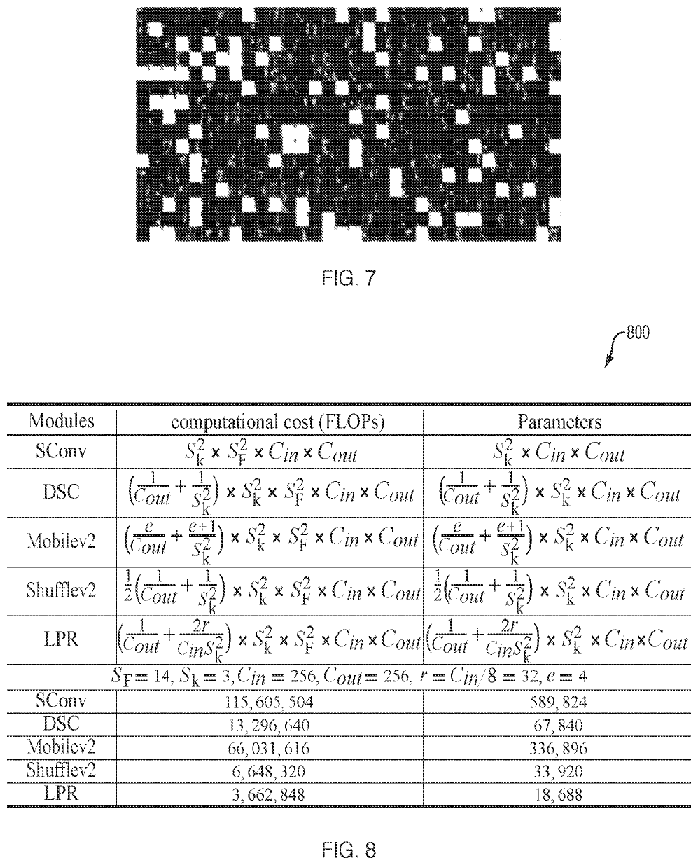

The visualization result is shown in FIG. 7. The result indicates that the example embodiment of a low-rank method can be employed to approach the output features of the pointwise layer.

FIG. 7 is a visualization of an example embodiment of sparse outputs after the pointwise convolutional layer (with BN and ReLU) processes an input feature map. In the example embodiment, a white patch indicates that the whole feature is 0.

LPR Structure

Example embodiments of an LPR module are disclosed above with reference to FIGS. 6A and 6B. As disclosed above, the depthwise convolution can be considered as the convolution between a diagonal matrix diag(D₁₁, . . . Dₘₘ) and a feature map matrix [F₁ . . . Fₘ]. According to an example embodiment, pointwise convolution may be performed in the following manner. To further reduce the size of matrix P, a low-rank decomposition of P may be employed such that P≈p⁽²⁾×p⁽¹, P⁽¹⁾∈R^{r×m}, P⁽²⁾∈R^{m×r}, r<<m. Clearly, the highest rank of this approximation is r, and the size of m×r is much smaller than m². As such, according to an example embodiment, the original DSC module, disclosed above, may be converted to:

F^{P}=(P⁽²⁾P⁽¹⁾)⊗F^{D} (16)

wherein F^{P} represents the output features after this new low-rank pointwise convolution operation. While using the strategy above may reduce the parameters and computational cost, it may undermine the original structure of P when r is inappropriately small, e.g., r<rank(P). To address this issue, an example embodiment adds a term F^{Res}=D⊗Fⁱⁿ, i.e., the original feature map after the depthwise convolution with D. This ensures that if the overall structure of P is compromised, the depthwise convolution is still able to capture the spatial features of the input.

Different from a popular residual learning where Fⁱⁿ is added to the module output, an example embodiment employs D⊗Fⁱⁿ instead. By considering this residual term, an example embodiment of a low-rank pointwise residual module may be formulated as:

(PD)⊗Fⁱⁿ≈F^{P}+F^{Res}=(P⁽²⁾P⁽¹⁾+I)D└Fⁱⁿ (17)

wherein I is an identity matrix. To further improve the performance, an example embodiment may normalized the features of F^{P} with L2 Normalization on the channel, and apply batch normalization on D. With the factorization of the large matrix P, an example embodiment of LPR successfully reduces the parameters and computational costs compared with other state-of-the-art modules. Theoretical comparisons among the prevalent lightweight modules are shown in table 800 (also referred to interchangeably herein as Table 4) of FIG. 8, disclosed below, wherein r=m/8.

FIG. 8 is a table 800 (also referred to interchangeably herein as Table 4) with example computational costs (i.e., FLOPs) and parameters for various lightweight modules for comparison. The lightweight modules include SConv, DSC, Shufflev2, Mobilev2, and LPR modules are used to build VGG, Mobilenetv1, Mobilenetv2, ShuffleNetv2 and LPRNet respectively. In table 800, an example embodiment of an LPR module as disclosed herein has the least computational cost and parameters when the input feature maps and output feature maps have a same number of dimensions. It should be noticed that 4r<m−Sₖ² is the sufficient and necessary condition that can make the LPR module have less computational cost and parameters than ShuffleNetv2 module. Thus, r is smaller than m/4−Sₖ²/4. Since Sₖ²/4 is usually much smaller compared with m, according to an example embodiment, r may be set to be approximately smaller than m/4 for easily choosing the number of the feature maps disclosed herein. P⁽²⁾ and P⁽¹⁾ are learned to approximate the optimized matrices through training.

Ablation Study

The disclosure below describes the experiment of r selection and is followed by an ablation study of an example embodiment of an LPR module. Further, an example embodiment of a low-rank approach disclosed herein is validated with an experiment on CIFAR-10.

To select the best rank r, the rank of the pointwise layer is explored first. Therefore, MobileNet was trained on CIFAR-10 and the rank of each pointwise layer was computed. The pointwise layer was only considered with the same dimension of the input and output. However, the weight of the 1×1 convolution layer is not as sparse as assumed. The result is shown in Table 5, below.

TABLE 5
Rank of 1 × 1 convolution weight and the approximate rank of whole
pointwise layer in MobileNetv1. The network is trained on CIFAR-10.

| Dimension of PW | Rank of 1 × 1 conv | Rank of PW |
|---|---|---|
| 128 × 128 | 128 | 112 |
| 256 × 256 | 255 | 181 |
| 512 × 512 | 511 | 361 |
| 512 × 512 | 512 | 341 |
| 512 × 512 | 512 | 371 |
| 512 × 512 | 512 | 351 |
| 512 × 512 | 511 | 337 |
| 1024 × 1024 | 1021 | 27 |

Thus, it is assumed that the sparsity of the outputs is brought by the BN layer and ReLU. However, to calculate the rank of the whole module is impossible due to its non-linear property. Therefore, the rank of the whole module is estimated using the training dataset. Input features and output features of each pointwise layer are extracted and the features down-sampled as 1×1 using average pooling. The rank of this layer is estimated with those two feature vectors. After running over the training datasets, the rank of each pointwise layer can be approximated. The result is also shown in Table 5, above. It can be observed from the table that the rank of the last layer is a great deal less than the rank of 1×1 convolution layer. This is because the CIFAR-10 dataset only has 10 labels. Therefore, only the rank of previous layers was used as guidance. After computing the mean rank, r should be no larger than 0.7m.

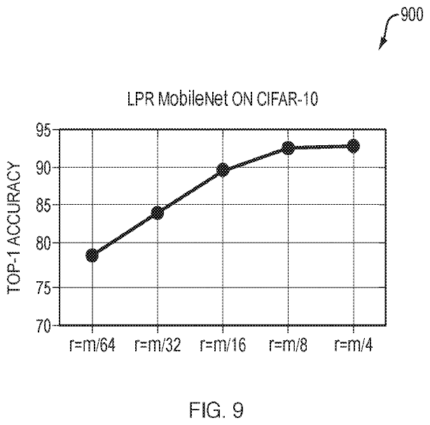

As disclosed above with regard to the LPR Structure, the rank r should be less than m/4 according to an example embodiment. Thus, a set of experiments on CIFAR-10 with MobileNetv1 architecture has been performed to select the best rank r during the low-rank decomposition, which is shown in Equation 17, above. The results are shown in FIG. 9, disclosed below.

FIG. 9 is a graph of an example embodiment of curves of different rank on CIFAR-10. From the graph, r=m/8 is the saturation point. The r=m/4 has a slightly better result relative to r=m/8. However, larger rank means larger parameters and computation cost, as shown in the Table 800 (i.e., Table 2) of FIG. 8, disclosed above.

To validate the effectiveness of different parts in an example embodiment of the LPR module, LPRNet was trained on the CIFAR-10 datasets after removing the L2 Normalization layer and residual part, respectively. The comparison results are shown in Table 6, below.

TABLE 6
Performance with different modules.

| Models | Accuracy | Parameters |
|---|---|---|
| SConv | 92.1% | 11M |
| DSC Module | 91.8% | 3.1M |
| LPR Module (no Residual) | 88.5% | 2.4M |
| LPR Module (no L2Norm) | 90.6% | 2.4M |
| LPR Module | 91.8% | 2.4M |

Since the parameters are fixed during the training, the only updated modules are DSC and LPR. Therefore, the similar accuracy among different modules means the weight matrices are similar. From Table 6, above, it is clear that the completed LPR module has a similar performance with the DSC module. However, its performance will drop after the residual part is removed. In addition, the performance will suffer a significant recession if the L2 Normalization layer is removed. Neither the residual part nor the L2 Normalization layer increases the parameters of the model.

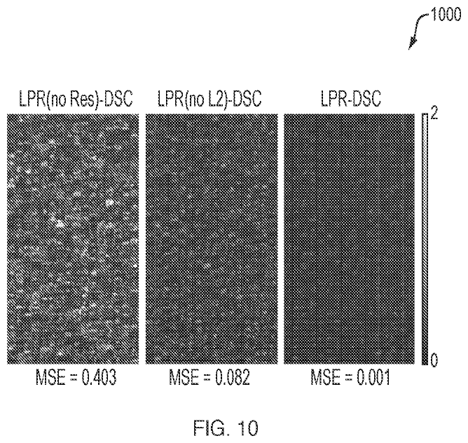

An experiment was designed to verify the ability of the Low-Rank approach of the LPR module. In the experiment, a network using standard convolution was trained on CIFAR-10. A layer with dimension is 512×512×14×14 was replaced by the DSC module, LPR without Residual, LPR without L2 Normalization, and the LPR module, respectively. The network was trained while all the other parameters remained fixed. The training process was stopped when the model achieved similar Top-1 validation accuracy with the original network. The similarities among output features are represented by Mean Squire Error (MSE) and visualized by the heatmaps. The results are shown in FIG. 10, disclosed below.

FIG. 10 is heatmap visualization 1000 of an example embodiment of differences among standard convolution, DSC, and LPR. The similarity is represented by MSE. The lower MSE means the two feature matrices have higher similarity. As shown in FIG. 10, the MSE between LPR and DSC is only 0.001, which means the output features from LPR and DSC have little difference. Since the other parameters of the network are fixed, similar output features mean the weights of the two modules are similar, which supports that the weight matrix of an example embodiment of the low-rank decomposition structure disclosed herein approaches the matrix of Depthwise Separable Convolution. It can also be observed from FIG. 10 that the MSE increases when the residual part and L2 Normalization are removed. Furthermore, the MSE increases more than 400 times when the residual part is removed from the LPR module, which indicates the learned weights are hard to approach the weights of the DSC.

Implementations

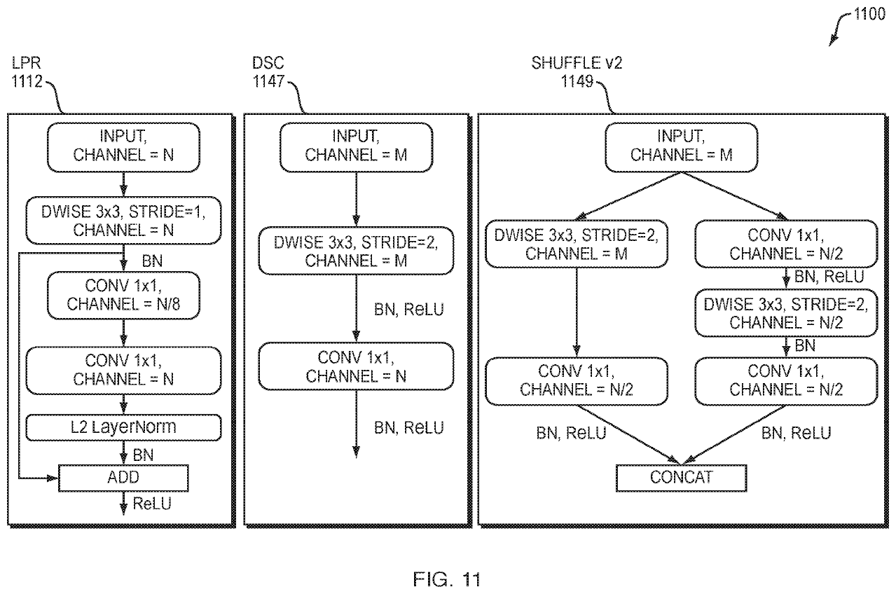

An example implementation embodies LPRNet based on an example embodiment of the LPR module and the deep learning structure of MobileNetv1 and ShuffleNetv2, respectively. The reason for choosing MobileNet (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017) and ShuffleNetv2 (Ningning Ma, Xiangyu Zhang, Hai-Tao Zheng, and Jian Sun. Shufflenet v2: Practical guidelines for efficient cnn architecture design. In ECCV, pages 122-138, 2018) is that most modules of these two networks have the same input dimension and output dimension, which is a condition to utilize the LPR module disclosed herein. The details of the modules used in LPRNet are shown in FIG. 11, disclosed below.

FIG. 11 is block diagram of an example embodiment of modules 1100 employed in an example embodiment of an implementation of LPRNet. The modules 1100 in LPRNet include the LPR module 1112, down-sample and expansion module 1147 using Depthwise Separable Convolution (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), and Down-sample and expansion module 1149 using ShuffleNetv2 module (ShuffleNetv2 Ningning Ma, Xiangyu Zhang, Hai-Tao Zheng, and Jian Sun. Shufflenet v2: Practical guidelines for efficient 19 cnn architecture design. In ECCV, pages 122-138. 2018). Since the input of the LPR module 1112 requires an identical input-output dimension, the downsample modules of the MobileNetv1 and ShuffleNetv2 are reserved in LPRNet disclosed herein. The rest of the modules are replaced by the LPR module 1112. The LPR module 1112 may also be embodied to MixNet-S (Mingxing J Tan and Quoc V Le. Mixnet: Mixed depthwise convolutional kernels. In BMVC, 2019). However, the architecture would be changed slightly since the basic structure of MixNet is Inverse Residual Block (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018). In the LPR module 1112, the input dimension and output dimension of the features maps input to the LPR module 1112 and output from the LPR module 1112 are the same due, to the add operator. As such, the DSC module 1147 and ShuffleNetv2 module 1149 are used for the down-sample and channel expansion. Note that the stride of the depthwise layer in the DSC module 1147 and ShuffleNetv2 module 1149 should be set as 1 for channel expansion.

Details of the architecture in LPRNet_{MobileNet} and LPR_{Netshufflev2} are disclosed below. A reason for choosing MobileNet Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017) and ShuffleNetv2 Ningning Ma, Xiangyu Zhang, Hai-Tao Zheng, and Jian Sun. Shufflenet v2: Practical guidelines for efficient 19 cnn architecture design. In ECCV, pages 122-138. 2018) is that the most modules of these two networks have the same input dimension and output dimension, which is a condition to utilize the LPR module 1112.

The architecture of LPRNet_{MobileNet} is shown in Table 7, below.

TABLE 7
The Architecture of LPRNetMobileNet (stride = 2 means down-sample).

| Input | Operator | Stride | Kernels | output |
|---|---|---|---|---|
| 224² × 3 | Sconv | 2 | 3 × 3 | 112² × 32 |
| 112² × 32 | DSC | 1 | — | 112² × 64 |
| 112² × 64 | DSC | 2 | — | 56² × 128 |
| 56² × 128 | LPR1 | 1 | — | 56² × 128 |
| 56² × 128 | DSC | 2 | — | 28² × 256 |
| 28² × 256 | LPR2 | 1 | — | 28² × 256 |
| 28² × 256 | DSC | 2 | — | 14² × 512 |
| 14² × 512 | LPR3 | 1 | — | 14² × 512 |
| 14² × 512 | LPR4 | 1 | — | 14² × 512 |
| 14² × 512 | LPR5 | 1 | — | 14² × 512 |
| 14² × 512 | LPR6 | 1 | — | 14² × 512 |
| 14² × 512 | LPR7 | 1 | — | 14² × 512 |
| 14² × 512 | DSC | 2 | — | 7² × 1024 |
| 7² × 1024 | LPR8 | 1 | — | 7² × 1024 |
| 7² × 1024 | Avg pool | — | 7 × 7 | 1² × 1024 |
| 1² × 1024 | FC | — | — | 1² × 1000 |

LPRNet_{MobileNet}×α has the same architecture as shown in the table but it multiplies the channel number of each layer with α. The architecture of LPR_{Netsufflev2} is shown in Table 8, below.

TABLE 8
The Architecture of LPRNetshufflev2 (stride = 2 means down-sample).

| Input | | | | | Output | |
|---|---|---|---|---|---|---|
| ×1 | ×2 | Operator | stride | Kernels | ×1 | ×2 |
| 224² × 3 | 224² × 3 | Sconv | 2 | 3 × 3 | 112² × 24 | 112² × 24 |
| 112² × 24 | 112² × 24 | Max pool | 2 | 3 × 3 | 56² × 24 | 56² × 24 |
| 56² × 24 | 56² × 24 | Shufflev2 | 2 | — | 28² × 116 | 28² × 244 |
| 28² × 116 | 28² × 244 | LPR1 | 1 | — | 28² × 116 | 28² × 244 |
| 28² × 116 | 28² × 244 | LPR2 | 1 | | 28² × 116 | 28² × 244 |
| 28² × 116 | 28² × 244 | LPR3 | 1 | — | 28² × 116 | 28² × 244 |
| 28² × 116 | 28² × 244 | Shufflev2 | 2 | — | 14² × 232 | 14² × 488 |
| 14² × 232 | 14² × 488 | LPR4 | 1 | — | 14² × 232 | 14² × 488 |
| 14² × 232 | 14² × 488 | LPR5 | 1 | — | 14² × 232 | 14² × 488 |
| 14² × 232 | 14² × 488 | LPR6 | 1 | — | 14² × 232 | 14² × 488 |
| 14² × 232 | 14² × 488 | LPR7 | 1 | — | 14² × 232 | 14² × 488 |
| 14² × 232 | 14² × 488 | LPR8 | 1 | — | 14² × 232 | 14² × 488 |
| 14² × 232 | 14² × 488 | LPR9 | 1 | — | 14² × 232 | 14² × 488 |
| 14² × 232 | 14² × 488 | LPR10 | 1 | — | 14² × 232 | 14² × 488 |
| 14² × 232 | 14² × 488 | Shufflev2 | 2 | — | 7² × 464 | 7² × 976 |
| 7² × 464 | 7² × 976 | LPR11 | 1 | — | 7² × 464 | 7² × 976 |
| 7² × 464 | 7² × 976 | LPR12 | 1 | — | 7² × 464 | 7² × 976 |
| 7² × 464 | 7² × 976 | LPR13 | 1 | — | 7² × 464 | 7² × 976 |
| 7² × 464 | 7² × 976 | Sconv | 1 | 1 × 1 | 7² × 1024 | 7² × 2048 |
| 7² × 1024 | 7² × 2048 | Avg pool | — | 7 × 7 | 1² × 1024 | 1² × 2048 |
| 1² × 1024 | 1² × 2048 | FC | — | — | 1² × 1000 | 1² × 1000 |

Experiments

Experiments were conducted on image classification and large poses Face Alignment tasks as disclosed below. Datasets, comparison methods, parameter settings, evaluation metrics, and show comparison results are presented with respect to same, as disclosed below.

Image Classification

Dataset: To make a fair comparison, the ImageNet 2012 classification dataset (Jia Deng, Wei Dong, Richard Socher, Li-Jia Li, Kai Li, and Li Fei-Fei. Imagenet: A large-scale hierarchical image database. In CVPR, pages 248-255, 2009), (Olga Russakovsky, Jia Deng, Hao Su, Jonathan Krause, San-jeev Satheesh, Sean Ma, Zhiheng Huang, Andrej Karpathy, Aditya Khosla, Michael Bernstein, et al. Imagenet large scale visual recognition challenge. IJCV, 115(3):211-252, 2015) was used. There are 128, 1167 images and 1,000 classes in the training dataset. The images in the training dataset are resized to 480×480 and are randomly cropped. The images in the validation dataset are resized to 256×256 and are center cropped. Some augmentations such as random flip, random scale, and random illumination are implemented on the training dataset. All the results are tested on the validation dataset.

Comparison Methods: An example embodiment of LPRNet is first compared with its underlying structures including ShuffleNetv2 (Ningning Ma, Xiangyu Zhang, Hai-Tao Zheng, and Jian Sun. Shufflenet v2: Practical guidelines for efficient cnn architecture design. In ECCV, pages 122-138, 2018), MobileNetv1 (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), and MixNet-S (Mingxing J Tan and Quoc V Le. Mixnet: Mixed depthwise convolutional kernels. In BMVC, 2019) respectively. Then a comparison of LPRNetShufflev2 and LPRNetMobileNet with manually designed lightweight architectures including MobileNetv1 (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), ShuffleNetv1 (Xiangyu Zhang, Xinyu Zhou, Mengxiao Lin, and Jian Sun. Shufflenet: An extremely efficient convolutional neural network for mobile devices. In CVPR, 2018), MobileNetv2 (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018), ShuffleNetv2 (Ningning Ma, Xiangyu Zhang, Hai-Tao Zheng, and Jian Sun. Shufflenet v2: Practical guidelines for efficient cnn architecture design. In ECCV, pages 122-138, 2018), SqueezeNext (Amir Gholami, Kiseok Kwon, Bichen Wu, Zizheng Tai, Xiangyu Yue, Peter Jin, Sicheng Zhao, and Kurt Keutzer. Squeezenext: Hardware-aware neural network design. In Proceedings of the IEEE Conference on Computer Vision and Pattern Recognition Workshops, pages 1638-1647, 2018), CondenseNet (Gao Huang, Shichen Liu, Laurens van der Maaten, and Kilian Q. Weinberger. Condensenet: An efficient densenet using learned group convolutions. In CVPR, June 2018), IGCV3 (Ke Sun, Mingjie Li, Dong Liu, and Jingdong Wang. Igcv3: Interleaved low-rank group convolutions for efficient deep neural networks. 2018), and ESPNetv2 (Sachin Mehta, Mohammad Rastegari, Linda Shapiro, and Hannaneh Hajishirzi. Espnetv2: A light-weight, power efficient, and general purpose convolutional neural network. CVPR, 2019). At last, a comparison is disclosed of the LPRNetMixNet with auto-searched architectures such as Darts (Hanxiao Liu, Karen Simonyan, and Yiming Yang. Darts: Differentiable architecture search. In ICLR, 2019), NasNet (Barret Zoph, Vijay Vasudevan, Jonathon Shlens, and Quoc V Le. Learning transferable architectures for scalable image recognition. In CVPR, pages 8697-8710, 2018), PNasNet (Chenxi Liu, Barret Zoph, Maxim Neumann, Jonathon Shlens, Wei Hua, Li-Jia Li, Li Fei-Fei, Alan Yuille, Jonathan Huang, and Kevin Murphy. Progressive neural architecture search. In ECCV, pages 19-34, 2018), ProxylessNas (Han Cai, Ligeng Zhu, and Song Han. Proxylessnas: Direct neural architecture search on target task and hardware. In ICLR, 2019), FBNet (Bichen Wu, Xiaoliang Dai, Peizhao Zhang, Yanghan Wang, Fei Sun, Yiming Wu, Yuandong Tian, Peter Vajda, Yangqing Jia, and Kurt Keutzer. Fbnet: Hardware-aware efficient con-vnet design via differentiable neural architecture search. In CVPR, pages 10734-10742, 2019), MNasNet (Mingxing Tan, Bo Chen, Ruoming Pang, Vijay Vasudevan, and Quoc V Le. Mnasnet: Platform-aware neural architecture search for mobile. In CVPR, 2019), MobileNetv3 (Andrew Howard, Mark Sandler, Grace Chu, Liang-Chieh Chen, Bo Chen, Mingxing Tan, Weijun Wang, Yukun Zhu, Ruoming Pang, Vijay Vasudevan, et al. Searching for mo-bilenetv3. In ICCV, 2019), and MixNet (Mingxing J Tan and Quoc V Le. Mixnet: Mixed depthwise convolutional kernels. In BMVC, 2019).

Parameter Settings: An example embodiment of a learning model is built by Mxnet framework (Tianqi Chen, Mu Li, Yutian Li, Min Lin, Naiyan Wang, Min-jie Wang, Tianjun Xiao, Bing Xu, Chiyuan Zhang, and Zheng Zhang. Mxnet: A flexible and efficient machine learning library for heterogeneous distributed systems. arXiv preprint arXiv:1512.01274, 2015). The optimizer is the large batch SGD (Leon Bottou. Large-scale machine learning with stochastic gradient descent. In COMPSTAT, pages 177-186, 2010) starting with the learning rate 0.5. The learning rate is decayed following cosine function. The total epoch number is set to 210 for LPRNetMobileNet, and 400 for LPRNetShufflev2. The batch size is set to 256 for LPRNetMobileNet and 400 for LPRNetShufflev2. The LPRNetMixNet was trained with the learning rate 0.5, epochs 260, and batch size 220. After training, the model was tuned on the same training dataset without data augmentation.

Evaluation Metrics: The performance was evaluated using Top-1 accuracy. Like other works (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018), (Ningning Ma, Xiangyu Zhang, Hai-Tao Zheng, and Jian Sun. Shufflenet v2: Practical guidelines for efficient cnn architecture design. In ECCV, pages 122-138, 2018), (Mingxing Tan, Bo Chen, Ruoming Pang, Vijay Vasudevan, and Quoc V Le. Mnasnet: Platform-aware neural architecture search for mobile. In CVPR, 2019), (Tien-Ju Yang, Andrew Howard, Bo Chen, Xiao Zhang, Alec Go, Mark Sandler, Vivienne Sze, and Hartwig Adam. Netadapt: Platform-aware neural network adaptation for mobile applications. ECCV, 41:46, 2018), the computational cost is evaluated using calculated FLOPs number, and the parameters are evaluated by the calculated number.

Comparison Results: First, LPRNet is compared to its underlying structures and results are shown in Table 9, below.

TABLE 9
Comparisons between LPRNet and its underlying structures on ImageNet.

| Methods | Top-1 | FLOPs | Parameters |
|---|---|---|---|
| ShuffleNetv2_{2018ECCV}X1.0 | 69.3% | 149M | 2.3M |
| LPRNet_{Shufflev2}X1.0 | 69.1% | 113M | 2.0M |
| MobileNetv1_{2017CoRR}X1.0 | 70.6% | 574M | 4.2M |
| LPRNet_{MobileNet}X1.0 | 70.6% | 260M | 2.3M |
| MixNet-S_{2019BMVC} | 75.8% | 256M | 4.1M |
| LPRNet_{MixNet} | 75.1% | 232M | 4.2M |

From Table 9, above, it can be observed that LPRNet performs best on MobileNet architecture, which reduces 55% computation cost and 46% parameters with no accuracy loss. Though the LPRShufflev2 has 0.2% lower accuracy than ShuffleNetv2, it reduces 25% computation cost and 17% parameters. The accuracy of LPRNetMixNet is 0.7% lower than MixNet. The reason is LPR doesn't approach the weight matrices of complex structures with unique modules (e.g., channel shuffle, severe channel expansion) as well as a regular pointwise layer.

Table 10, below, shows the comparison results of manually designed architectures.

TABLE 10
Performance comparison with manually designed networks on ImageNet.

| Methods | Top-1 | FLOPs | parameters |
|---|---|---|---|
| ShuffleNetv1_{2018CVPR}X0.25 | 38.5% | 13M | 368K |
| ShuffleNetv2_{2018ECCV}X0.25 | 43.0% | 14M | 587K |
| MobileNetv1_{2017CoRR}X0.25 | 50.6% | 42M | 470K |
| ShuffleNetv1_{2018CVPR}X0.5 | 56.8% | 41M | 718K |
| 1.0-SqNxt-23_{2018CVPRW} | 57.7% | 287M | 724K |
| LPRNet_{MobileNet}X0.5 | 63.2% | 78M | 869K |
| ShuffleNetv1_{2018CVPR}X1.0 | 67.4% | 140M | 2.2M |
| ESPNetv2_{2019CVPR}X1.5 | 67.9% | 185M | 2.3M |
| IGCV3_{2018BMVC}X0.75 | 69.1% | 210M | 2.6M |
| ShuffleNetv2_{2018ECCV}X1.0 | 69.3% | 149M | 2.3M |
| CondenseNet_{2018CVPR} | 70.3% | 291M | 2.9M |
| LPRNet_{MobileNet}X1.0 | 70.6% | 260M | 2.3M |
| MobileNetv1_{2017CoRR}X0.75 | 68.4% | 325M | 3.6M |
| ESPNetv2_{2019CVPR}X2.0 | 71.0% | 306M | 3.5M |
| ShuffleNetv1_{2018CVPR}X1.5 | 71.5% | 292M | 3.4M |
| IGCV3_{2018BMVC}X1.0 | 71.7% | 340M | 3.4M |
| MobileNetv2_{2018CVPR}X1.0 | 72.0% | 301M | 3.5M |
| LPRNet_{MobileNet}X1.25 | 72.8% | 389M | 3.4M |
| MobileNetv1_{2017CoRR}X1.0 | 70.6% | 574M | 4.2M |
| ShuffleNetv1_{2018CVPR}X2.0 | 73.4% | 524M | 5.4M |
| LPRNet_{Shuffle2}X2.0 | 73.8% | 437M | 6.2M |
| ShuffleNetv2_{2018ECCV}X2.0 | 74.1% | 595M | 7.6M |
| MobileNetv2_{2018CVPR}X1.4 | 74.4% | 585M | 6.9M |
| LPRNet_{MobileNet}X1.5 | 74.6% | 544M | 4.5M |

Table 10, above, is divided into four regions based on the size of the parameters. In each region, the methods are ordered based on their Top-1 accuracy. Compared with other methods, LPRNet also achieves the best performance with approximately the same complexity. When the parameters are reduced to the K level, an example embodiment of LPRNet has over 63% Top-1 accuracy while the accuracy of all other methods is below 57%. When the parameters are larger than 4M, LPRNetShufflev2 has the least computation cost and comparable accuracy, and LPRNetMobileNet has the highest accuracy with the second least parameters and third least computation cost.

The comparison results between LPRNetMixNet and auto-searched networks are shown in Table 11, below.

TABLE 11
Comparisons between the LPRNetMixNet and auto-searched networks
on ImageNet.

| Methods | Top-1 | FLOPs | Parameters |
|---|---|---|---|
| Darts_{2019ICLR} | 73.1% | 595M | 4.9M |
| NasNet-A_{2018CVPR} | 74.0% | 564M | 5.3M |
| PNasNet_{2018ECCV} | 74.2% | 588M | 5.1M |
| ProxylessNas_{2019ICLR} | 74.6% | 320M | 4.1M |
| FBNet-_{C2019CVPR} | 74.9% | 375M | 5.5M |
| MNasNet-Al_{2019CVPR} | 75.2% | 312M | 3.9M |
| MobileNetv3_{20191CCV} | 75.1% | 219M | 5.4M |
| MixNet-S_{2019BMVC} | 75.8% | 256M | 4.1M |
| LPRNet_{MixNet} | 75.1% | 232M | 3.8M |
| LPRNet_{MixNet+Mobilev3} | 75.1% | 219M | 4.6M |
| LPRNet × 0.875_{MixNet+Mobilev3} | 74.6% | 197M | 4.2M |

As disclosed in Table 11, above, an example embodiment of LPRNet disclosed herein is 0.7% less than the most accurate architecture MixNet-S. However, it is only 0.1% less than the second accurate model, which is MobileNetv3. Furthermore, LPRNet has the second least computational cost and third least parameters across all other auto-searched networks. Comparing with NAS, training of LPRNet only costs 190 GPU hours for 260 epochs, which is easy re-implemented with limited computing resources. Further, a search for the best hyperparameters (e.g., rank for different layers, etc.) was not performed and, as such, LPRNet can be potentially improved.

Large Poses Face Alignment

Datasets: In the face alignment experiments disclosed herein, all of the baselines use 68-point landmarks to conduct fair comparisons. All of the baselines are evaluated with only x-y coordinates for fair comparisons, since some datasets (Adrian Bulat and Georgios Tzimiropoulos. How far are we from solving the 2d & 3d face alignment problem?(and a dataset of 230,000 3d facial landmarks). In ICCV, pages 1021-1030, 2017) used only have 2D coordinates projected from 3D landmarks. Training datasets are 300W-LP (Xiangyu Zhu, Zhen Lei, Xiaoming Liu, Hailin Shi, and Stan Z Li. Face alignment across large poses: A 3d solution. In CVPR, pages 146-155, 2016), while testing datasets are AFLW2000-3D (Xiangyu Zhu, Zhen Lei, Xiaoming Liu, Hailin Shi, and Stan Z Li. Face alignment across large poses: A 3d solution. In CVPR, pages 146-155, 2016), Re-annotated AFLW2000-3D (Adrian Bulat and Georgios Tzimiropoulos. How far are we from solving the 2d & 3d face alignment problem?(and a dataset of 230,000 3d facial landmarks). In ICCV, pages 1021-1030, 2017), LS3D-W (Adrian Bulat and Georgios Tzimiropoulos. How far are we from solving the 2d & 3d face alignment problem?(and a dataset of 230,000 3d facial landmarks). In ICCV, pages 1021-1030, 2017) which has 5 sub-dataset Menpo-3D (8,955 images), 300W-3D (600 images), and 300VW-3D (A, B, and C).

Comparison Methods: Comprehensive evaluations were conducted with state-of-the-art methods. A comparison is made with state-of-the-art deep methods including PCD-CNN (Amit Kumar and Rama Chellappa. Disentangling 3d pose in a dendritic cnn for unconstrained 2d face alignment. CVPR, 2018), 3DFAN (Adrian Bulat and Georgios Tzimiropoulos. How far are we from solving the 2d & 3d face alignment problem?(and a dataset of 230,000 3d facial landmarks). In ICCV, pages 1021-1030, 2017), Hyperface (Rajeev Ranjan, Vishal M Patel, and Rama Chellappa. Hyper-face: A deep multi-task learning framework for face detection, landmark localization, pose estimation, and gender recognition. TPAMI, 2017), 3DSTN (Chandrasekhar Bhagavatula, Chenchen Zhu, Khoa Luu, and Marios Savvides. Faster than real-time facial alignment: A 3d spatial transformer network approach in unconstrained poses. ICCV, 2, 2017), 3DDFA (Xiangyu Zhu, Zhen Lei, Xiaoming Liu, Hailin Shi, and Stan Z Li. Face alignment across large poses: A 3d solution. In CVPR, pages 146-155, 2016), and MDM (George Trigeorgis, Patrick Snape, Mihalis A Nico-laou, Epameinondas Antonakos, and Stefanos Zafeiriou. Mnemonic descent method: A recurrent process applied for end-to-end face alignment. In CVPR, pages 4177-4187, 2016). Among these baselines, the results of 3DSTN and PCD-CNN are cited from the original papers. The accuracy and speed on CPU is also compared, with some of those methods only running on CPU, including SDM (Xuehan Xiong and Fernando De la Torre. Supervised descent method and its applications to face alignment. In CVPR, pages 532-539, 2013), ERT (Vahid Kazemi and Josephine Sullivan. One millisecond face alignment with an ensemble of regression trees. In CVPR, pages 1867-1874, 2014), and ESR (Xudong Cao, Yichen Wei, Fang Wen, and Jian Sun. Face alignment by explicit shape regression. JCV, 107(2):177-190, 2014). To make a fair comparison, the lightweight models MobileNet (Andrew G Howard, Menglong Zhu, Bo Chen, Dmitry Kalenichenko, Weijun Wang, Tobias Weyand, Marco Andreetto, and Hartwig Adam. Mobilenets: Efficient convolutional neural networks for mobile vision applications. CoRR, abs/1704.04861, 2017), (Mark Sandler, Andrew Howard, Menglong Zhu, Andrey Zhmoginov, and Liang-Chieh Chen. Inverted residuals and linear bottlenecks: Mobile networks for classification, detection and segmentation. CVPR, 2018) and ShuffleNet (Xiangyu Zhang, Xinyu Zhou, Mengxiao Lin, and Jian Sun. Shufflenet: An extremely efficient convolutional neural network for mobile devices. In CVPR, 2018), (Ningning Ma, Xiangyu Zhang, Hai-Tao Zheng, and Jian Sun. Shufflenet v2: Practical guidelines for efficient cnn architecture design. In ECCV, pages 122-138, 2018) are implemented for face alignment and are trained on the same datasets. All these models are using half channels for fast training and testing.

Parameter Settings: An example embodiment of a structure is built by Mxnet framework (Tianqi Chen, Mu Li, Yutian Li, Min Lin, Naiyan Wang, Min-jie Wang, Tianjun Xiao, Bing Xu, Chiyuan Zhang, and Zheng Zhang. Mxnet: A flexible and efficient machine learning library for heterogeneous distributed systems. arXiv preprint arXiv:1512.01274, 2015) and uses L2 loss specified for regression task. Adam stochastic optimization (Diederik Kingma and Jimmy Ba. Adam: A method for stochastic optimization. ICLR, 2014) is used with default hyper-parameters to learn the weights. The initial learning rate is set to 0.0005, and the initialized weights are generated with Xavier initialization. The epoch is set to 60 and the batch size is set to 100. The learning rate is set to 4e⁻⁴ at the first 15 epoch and then the learning rate is decayed to 2e⁻⁴ when the number of channels is multiplied by 0.5.

Evaluation Metrics: Ground-truth landmarks were used to generate bounding boxes. “Normalized Mean Error (NME)” is a useful metric for face alignment evaluation, which is defined as:

$$N M E = \frac{1}{N} {\sum }_{i = 1}^{N} \frac{{‖ {\hat{X}}_{i} - {X}_{i}^{*} ‖}_{2}}{d}$$

wherein \vec{X} and X* are predicted and ground truth landmarks, respectively, and Nis the number of the landmarks. d can be computed using d=\sqrt{w_{bbox}×h_{bbox}}, wherein w_{bbox} and h_{bbox} are the width and height of the bounding box, respectively. The speed of all methods was evaluated on Intel® Core™ i7 processor. Frames Per Second (FPS) were used to evaluate the speed. The storage size herein is calculated from binary models.

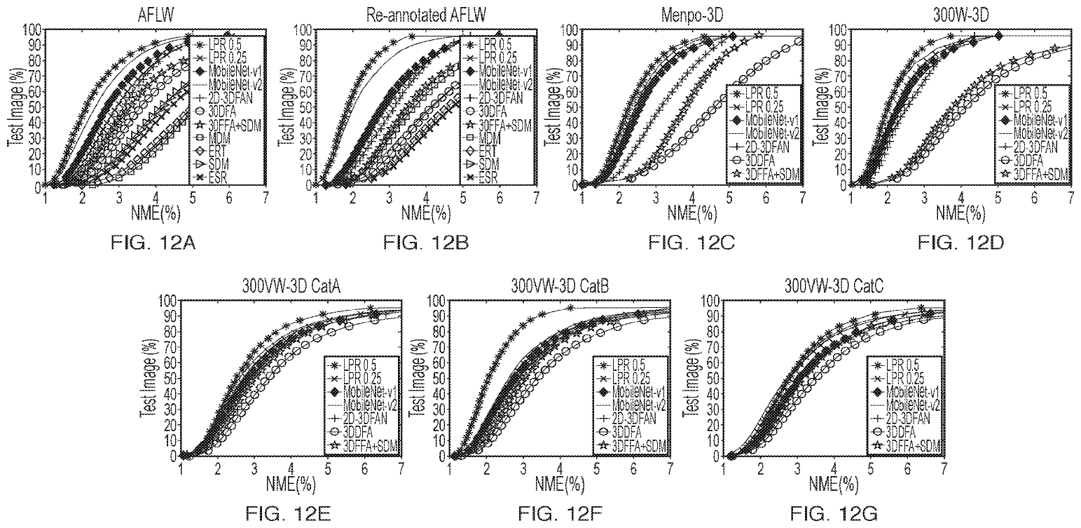

Comparison Results: To compare the performance of the different range of angles, the testing dataset was divided into three parts by the range of the angles of the faces (Xiangyu Zhu, Zhen Lei, Xiaoming Liu, Hailin Shi, and Stan Z Li. Face alignment across large poses: A 3d solution. In CVPR, pages 146-155, 2016). The curve of the cumulative errors distribution (CED) of the whole dataset is shown in FIGS. 12A-G, disclosed below.

FIGS. 12A-G are graphs of example embodiments of CED curves on different test datasets. The baselines on whole datasets of AFLW2000-3D, re-annotated AFLW2000-3D, Menpo-3D, 300W-3D, and 300VW-3D were tested. The top-left curve means the method has the best performance, i.e., most cases below given NME. The visualization comparison results are shown in FIG. 13, disclosed below.

FIG. 13 is a visualization 1300 of comparison results of lightweight models.

FIG. 14 is a table 1400 (referred to interchangeably herein as Table 12) of comparisons between example embodiments of LPR methods and state-of-the-art methods on an AFLW2000-3D dataset. From table 1400, that is, Table 12, it can be observed that the NME of an example embodiment of LPRNet×0.5 is 5% lower than the current state-of-the-art PCD-CNN. Compared with those conventional deep learning methods (Rajeev Ranjan, Vishal M Patel, and Rama Chellappa. Hyper-face: A deep multi-task learning framework for face detection, landmark localization, pose estimation, and gender recognition. TPAMI, 2017), (Chandrasekhar Bhagavatula, Chenchen Zhu, Khoa Luu, and Marios Savvides. Faster than real-time facial alignment: A 3d spatial transformer network approach in unconstrained poses. ICCV, 2, 2017), [63] (Xiangyu Zhu, Zhen Lei, Xiaoming Liu, Hailin Shi, and Stan Z Li. Face alignment across large poses: A 3d solution. In CVPR, pages 146-155, 2016), (Adrian Bulat and Georgios Tzimiropoulos. How far are we from solving the 2d & 3d face alignment problem?(and a dataset of 230,000 3d facial landmarks). In ICCV, pages 1021-1030, 2017), (Geoffrey Hinton, Oriol Vinyals, and Jeff Dean. Distilling the knowledge in a neural network. NIPS, 2015), (George Trigeorgis, Patrick Snape, Mihalis A Nico-laou, Epameinondas Antonakos, and Stefanos Zafeiriou. Mnemonic descent method: A recurrent process applied for end-to-end face alignment. In CVPR, pages 4177-4187, 2016), the example embodiment of LPRNet has much better speed on both one core CPU and GPU, and it is ×120 smaller than the smallest model in baseline traditional deep learning methods.

Compared with other lightweight models, the NME of an example embodiment of LPRNet×0.25 achieves similar performance as MobileNetv1 and MobileNetv2 but with ×1.8 speed on CPU and 73% compression ratio. In addition, it is ×3.4 smaller than the smallest model ShuffleNetv1 with much lower NME. In table 1400 of FIG. 14, that is, Table 12, it can be observed that the SDM (Xuehan Xiong and Fernando De la Torre. Supervised descent method and its applications to face alignment. In CVPR, pages 532-539, 2013), ERT (Vahid Kazemi and Josephine Sullivan. One millisecond face alignment with an ensemble of regression trees. In CVPR, pages 1867-1874, 2014) and ESR (Xudong Cao, Yichen Wei, Fang Wen, and Jian Sun. Face alignment by explicit shape regression. JCV, 107(2):177-190, 2014) have very impressive speed on CPU. The reason is that such methods use hand-crafted features, which are easy to compute but have limited ability for representation.

In light of the disclosure above, an example embodiment of a lightweight deep learning module, referred to herein as LPR, further reduces the network parameters through low-rank matrix decomposition and residual learning. By applying the LPR module to MobileNet and ShuffleNetv2, the size of existing lightweight models was reduced. The LPR module was also applied to auto-searched network MixNet and achieved comparable performance, competing with other auto-searched methods. In addition, on image classification and face alignment tasks, the LPR module compared to many state-of-the-art deep learning models, and LPRNet had much lower parameters and computational cost, but kept very competitive or even better performance. As such, an example embodiment of an LPR module disclosed herein casts light on deep models compression through low-rank matrix decomposition and enables many powerful deep models to be deployed in end devices.

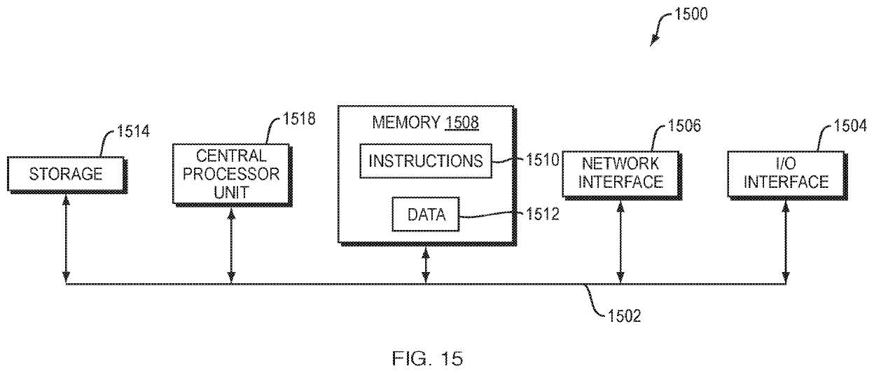

FIG. 15 is a block diagram of an example of the internal structure of a computer 1500 in which various embodiments of the present disclosure may be implemented. The computer 1500 contains a system bus 1502, where a bus is a set of hardware lines used for data transfer among the components of a computer or processing system. The system bus 1502 is essentially a shared conduit that connects different elements of a computer system (e.g., processor, disk storage, memory, input/output ports, network ports, etc.) that enables the transfer of information between the elements. Coupled to the system bus 1502 is an I/O device interface 1504 for connecting various input and output devices (e.g., keyboard, mouse, displays, printers, speakers, etc.) to the computer 1500. A network interface 1506 allows the computer 1500 to connect to various other devices attached to a network. Memory 1508 provides volatile or non-volatile storage for computer software instructions 1510 and data 1512 that may be used to implement embodiments of the present disclosure, where the volatile and non-volatile memories are examples of non-transitory media. Disk storage 1514 provides non-volatile storage for computer software instructions 1510 and data 1512 that may be used to implement embodiments of the present disclosure. A central processor unit 1518 is also coupled to the system bus 1502 and provides for the execution of computer instructions.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 15, disclosed above, or equivalents thereof, firmware, a combination thereof, or other similar implementation determined in the future.

For example, it should be understood that neural network architectural structures labelled with terms such as, “neural network element,”, “depthwise module,” “pointwise module,” “block,” “decomposition convolutional module,” “concatenator,” “add operator,” “compression module,” “processing module,” “recovery module,” “layer,” “element,” “regressor,” “LPR module,” etc., in block and flow diagrams disclosed herein, such as, FIGS. 1B, 2A, 2B, 3A, 6A, 6B, etc., disclosed above, may be implemented in software/firmware, such as via one or more arrangements of circuitry of FIG. 15, disclosed above, equivalents thereof, integrated circuit(s) (e.g., field programmable gate array (FPGA), application-specific integrated circuit (ASIC), etc.), or combination thereof.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A neural network comprising a neural network element, the neural network element including:
a depthwise convolutional layer configured to output respective features by performing spatial convolution of respective input features having an original number of dimensions;
a first convolutional layer configured to output respective features as a function of respective input features, the respective features output from the first convolutional layer having a reduced number of dimensions relative to the original number of dimensions;
a second convolutional layer configured to output respective features as a function of the respective features output from the first convolutional layer, the respective features output from the second convolutional layer having the original number of dimensions; and
an add operator configured to output respective features as a function of the respective features output from the second convolutional layer and the respective features output from the depthwise convolutional layer.

2. The neural network of claim 1, wherein the respective input features to the first convolutional layer are the respective input features to the depthwise convolutional layer.

3. The neural network of claim 1, wherein the first convolutional layer, second convolutional layer, and depthwise convolutional layer are further configured to normalize, via batch normalization, the respective features output therefrom and wherein the first convolutional layer and depthwise convolutional layer are further configured to apply an activation function to the respective features normalized.

4. The neural network of claim 3, wherein the activation function is a rectified linear unit (ReLU) activation function configured to (i) output a given input feature, directly, in an event the given input feature has a positive value and (ii) output zero for the given input feature, otherwise.

5. The neural network of claim 1, wherein the neural network element further comprises an output processing layer configured to:
output respective features by normalizing, via batch normalization, the respective features output from the add operator; and
apply an activation function to the respective features normalized, wherein the activation function is a non-linear activation function.

6. The neural network of claim 1, wherein the neural network element is a depthwise module and wherein the neural network further comprises a pointwise module, the pointwise module including:
a first pointwise convolutional layer configured to output respective features as a function of respective input features;
a second pointwise convolutional layer configured to output respective features as a function of respective features output from the first pointwise convolutional layer; and
a concatenator configured to output respective features by concatenating the respective features output from the first pointwise convolutional layer with the respective features output from the second pointwise convolutional layer.

7. The neural network of claim 6, wherein the first and second pointwise convolutional layers are further configured to normalize, via batch normalization, the respective features output therefrom and to apply an activation function to the respective features normalized.

8. The neural network of claim 6, wherein the depthwise convolutional layer is a first depthwise convolutional layer, wherein the depthwise module is a first depthwise module, wherein the pointwise module is a first pointwise module, and wherein the neural network further comprises:
a compression module configured to output respective features as a function of respective input features having the original number of dimensions, the compression module including a second depthwise convolutional layer, the first pointwise module, and the first depthwise module, the respective features output from the compression module having the reduced number of dimensions;
a processing module configured to output respective features as a function of the respective features output from the compression module, the processing module including a third depthwise convolutional layer and a first concatenator; and
a recovery module configured to output respective features as a function of the respective features output from the processing module, the recovery module including a second depthwise module, a second pointwise module, and a second concatenator, the respective features output from the recovery module having the original number of dimensions.

9. The neural network of claim 8, wherein:
the second depthwise convolutional layer is configured to output respective features by performing spatial convolution of the respective input features to the compression module;
the first pointwise module is configured to output respective features as a function of the respective features output from the second depthwise convolutional layer;
the first depthwise module is configured to output respective features as a function of the respective features output from the first pointwise module;
the third depthwise convolutional layer is configured to output respective features as a function of the respective features output from the first depthwise module;
the first concatenator is configured to output respective features by concatenating the respective features output from the first depthwise module with the respective features output from the third depthwise convolutional layer;
the second depthwise module is configured to output respective features as a function of the respective features output from the first concatenator;
the second pointwise module is configured to output respective features as a function of the respective features output from the second depthwise module; and
the second concatenator is configured to output respective features from the recovery module by concatenating the respective features output from the second pointwise module with the respective features output from the first depthwise module.

10. The neural network of claim 9, wherein the second and third depthwise convolutional layers are further configured to normalize, via batch normalization, the respective features output therefrom and to apply an activation function to the respective features normalized.

11. The neural network of claim 1, wherein the respective input features to the first convolutional layer are the respective features output from the depthwise convolutional layer.

12. The neural network of claim 1, wherein the depthwise convolutional layer is further configured to normalize, via batch normalization, the respective features output therefrom.

13. The neural network of claim 1, wherein the neural network element further comprises an L2 normalization layer configured to output respective features by applying L2 normalization to the respective features output from the second convolutional layer and wherein the neural network element is configured to batch normalize the respective features output from the L2 normalization layer.

14. The neural network of claim 13, wherein the add operator is further configured to output the respective features by adding:
the respective feature maps output from the second convolutional layer, normalized by the L2 normalization layer, and batch normalized; and
the respective feature maps output from the depthwise convolutional layer.

15. The neural network of claim 14, wherein the neural network element is further configured to apply an activation function to the respective features output from the add operator and wherein the activation function is a non-linear activation function.

16. The neural network of claim 1, wherein the neural network is a deep convolutional neural network (DCNN).

17. The neural network of claim 1, wherein the neural network is employed by an application to perform, on a mobile or embedded device, at least one of: face alignment, face synthesis, image classification, or pose estimation.

18. A method of processing data in a neural network, the method comprising:
outputting respective features from a depthwise convolutional layer of a network element of the neural network by performing spatial convolution of respective input features having an original number of dimensions;
outputting respective features from a first convolutional layer of the network element as a function of respective input features, the respective features output from the first convolutional layer having a reduced number of dimensions relative to the original number of dimensions;
outputting respective features from a second convolutional layer of the network element as a function of the respective features output from the first convolutional layer, the respective features output from the second convolutional layer having the original number of dimensions; and
outputting respective features from an add operator of the network element as a function of the respective features output from the second convolutional layer and the respective features output from the depthwise convolutional layer.

19. The method of claim 18, further comprising inputting the respective input features to the first convolutional layer to the depthwise convolutional layer.

20. The method of claim 18, further comprising:
normalizing, via batch normalization, the respective features output from the first, second, and depthwise convolutional layers at the first, second, and depthwise convolutional layers, respectively; and
applying, at the first convolutional layer and depthwise convolutional layer, an activation function to the respective features normalized and output therefrom.

21. The method of claim 18, wherein applying the activation function includes applying a rectified linear unit (ReLU) activation function configured to (i) output a given input feature, directly, in an event the given input feature has a positive value and (ii) output zero for the given input feature, otherwise.

22. The method of claim 18, further comprising, at an output processing layer of the neural network element:
outputting respective features by normalizing, via batch normalization, the respective features output from the add operator; and
applying an activation function to the respective features normalized, wherein the activation function is a non-linear activation function.

23. The method of claim 18, wherein the neural network element is a depthwise module, wherein the neural network further comprises a pointwise module, and wherein the method further comprises:
outputting respective features from a first pointwise convolutional layer of the pointwise module as a function of respective input features;
outputting respective features from a first pointwise convolutional layer of the pointwise module as a function of respective features output from the first pointwise convolutional layer; and
outputting respective features from a concatenator of the pointwise module by concatenating the respective features output from the first pointwise convolutional layer with the respective features output from the second pointwise convolutional layer.

24. The method of claim 23, further comprising normalizing, via batch normalization, the respective features output from the first and second pointwise convolutional layers, at the first and second pointwise convolutional layers, respectively, and applying an activation function to the respective features normalized.

25. The method of claim 23, wherein the depthwise convolutional layer is a first depthwise convolutional layer, wherein the depthwise module is a first depthwise module, wherein the pointwise module is a first pointwise module, and wherein the method further comprises:
outputting respective features from a compression module in the neural network as a function of respective input features having the original number of dimensions, the compression module including a second depthwise convolutional layer, the first pointwise module, and the first depthwise module, the respective features output from the compression module having the reduced number of dimensions;
outputting respective features from a processing module in the neural network as a function of the respective features output from the compression module, the processing module including a third depthwise convolutional layer and a first concatenator; and
outputting respective features from a recovery module as a function of the respective features output from the processing module, the recovery module including a second depthwise module, a second pointwise module, and a second concatenator, the respective features output from the recovery module having the original number of dimensions.

26. The method of claim 25, further comprising:
outputting respective features from the second depthwise convolutional layer by performing spatial convolution of the respective input features input to the compression module;
outputting respective features from the first pointwise module as a function of the respective features output from the second depthwise convolutional layer;
outputting respective features from the first depthwise module as a function of the respective features output from the first pointwise module;
outputting respective features from the third depthwise convolutional layer as a function of the respective features output from the first depthwise module;
outputting respective features from the first concatenator by concatenating the respective features output from the first depthwise module with the respective features output from the third depthwise convolutional layer;
outputting respective features from the second depthwise module as a function of the respective features output from the first concatenator;
outputting respective features from the second pointwise module as a function of the respective features output from the second depthwise module; and
outputting respective features from the second concatenator by concatenating the respective features output from the second pointwise module with the respective features output from the first depthwise module.

27. The method of claim 26, further comprising normalizing, via batch normalization, the respective features output from the second and third depthwise convolutional layers and applying an activation function to the respective features normalized.

28. The method of claim 18, further comprising outputting the respective features from the depthwise convolutional layer to the first convolutional layer.

29. The method of claim 18, further comprising normalizing, via batch normalization, the respective features output from the depthwise convolutional layer.

30. The method of claim 18, further comprising outputting respective features by applying L2 normalization to the respective features output from the second convolutional layer and normalizing the respective features output from the L2 normalization layer via batch normalization.

31. The method of claim 30, further comprising outputting the respective features from the add operator by adding:
the respective feature maps output from the second convolutional layer, normalized by the L2 normalization layer, and batch normalized; and
the respective feature maps output from the depthwise convolutional layer.

32. The method of claim 31, further comprising applying an activation function to the respective features output from the add operator and wherein the activation function is a non-linear activation function.

33. The method of claim 18, wherein the neural network is a deep convolutional neural network (DCNN).

34. The method of claim 18, wherein the data includes each of the respective input features and wherein the method further comprises processing the data in the neural network to perform, on a mobile or embedded device, at least one of: face alignment, face synthesis, image classification, or pose estimation.

35. A method for processing data in a neural network, the method comprising:
decomposing a larger pointwise convolutional module into two matrices through network learning in the neural network, the larger pointwise convolutional module being larger relative to the two matrices;
performing pointwise convolution of input features using the two matrices; and
compensating for information loss in output features produced via the pointwise convolution performed, the compensating including applying residual learning to the output features.
